(19) United States
(12) Patent Application Publication
(10) Pub. No.: US 2015/0170391 A1
(43) Pub. Date: Jun. 18, 2015

(54) INTELLIGENT DISPLAY SYSTEM AND METHOD

(71) Applicant: TACTILE WORLD LTD., Raanana (IL)

(72) Inventors: Igor KARASIN, Raanana (IL); Yulia WOHL, Raanana (IL); Gavriel KARASIN, Raanana (IL)

(73) Assignee: TACTILE WORLD LTD., Raanana (IL)

(21) Appl. No.: 14/513,754

(22) Filed: Oct. 14, 2014

Related U.S. Application Data
(63) Continuation of application No. 13/642,218, filed on Oct. 19, 2012, now abandoned.
(60) Provisional application No. 61/282,903, filed on Apr. 19, 2010.

(51) Int. Cl. G06T 11/60

(52) U.S. Cl. CPC G06T 11/60

(57) ABSTRACT

An intelligent data display system includes a complex data source for the storage and display on a visual display device of data of different types, an image channel for the extraction and transformation of image data, and for the provision of transformed image data as a formatted image data output; a text channel for the extraction and transformation of text data, and for the provision of transformed text data as a formatted text data output; and an output for receiving the formatted data output and for redisplaying it on the display device.

### CROSS REFERENCE TO RELATED APPLICATIONS

This is a Continuation of co-pending U.S. patent application Ser. No. 13/642,218, filed Oct. 19, 2012, which is the National Stage of International Patent Application No. PCT/IL2011/000321, filed Apr. 17, 2011, which claimed priority to U.S. Provisional Patent Application No. 61/282,903, filed Apr. 19, 2010.

### FIELD OF THE INVENTION

The present invention relates to a display system and method, particularly useful for assisting the visually impaired in the viewing of textual, graphical and contextual data displayed on a computer screen.

### BACKGROUND OF THE INVENTION

Visually impaired individuals are able to view textual and graphical data displayed on a computer screen by means of various assistive devices, such as those which increase the size of text and images.

Among known devices intended to assist the visually impaired with the use of a computer, are screen magnifiers, such as those of ZoomIt (Microsoft Inc., http://technet.microsoft.com/en-us/sysinternals/bb897434.aspx); MAGic® Screen Magnification Software (Freedom Scientific Inc, http://www.freedomscientific.com/products/1v/magic-b1-product-page.asp); ZoomText Magnifier (AI Squared http://www.aisquared.com). These and others facilitate improved access by the visually impaired to computer based information, but do not permit the display of information in a manner most convenient for each individual user as will be understood from the description below.

Referring initially to FIG. 1a, there is shown a screen shot of a website, a portion of which is to be magnified by use of a prior art system described below in conjunction with FIGS. 1c and 1d, and such as exemplified above. The complete illustrated screen shot is the “available area”, with an “area of interest” shown in a rectangle 401 and an area of concentration shown within a frame 402. The location of the cursor 410, determines, in the present example, the upper left corner of an area 403 selected to be magnified, and thus the entire area to be magnified. It is seen that area 403 which is shown separately in FIG. 1b, includes both text fragments and a portion of a graphic image.

Referring now to FIG. 1c, there is shown, in block diagram form, an exemplary prior art magnification system for assisting visually impaired readers in viewing, for example, the website exemplified in FIGS. 1a and 1b. The system includes a data source referenced 10, a channel, referenced 1 for the magnification of screen data, and a control referenced 16 for operation by a user referenced 15. The illustrated system magnifies and displays the data without regard to its contents and character, whether the data includes images, text, interface elements, or any combination thereof, showing all data in the area selected for magnification.

By way of clarification, “data source” is used in the present description to mean all of the currently visible data elements or objects on a screen display, together with their descriptors, as described herein.

Referring now to FIG. 1d which is a detailed representation of the system shown in FIG. 1c, an image of a portion of the displayed data is extracted from the display by an extractor 11, constituted by software well known in the art, not detailed herein. In particular each programming language contains a set of special functions serving for extraction of image from the computer screen or any portion thereof. Initially a user decides upon an area of interest 401 (FIG. 1a) on a portion of which he will wish to concentrate his attention, as seen at 402 (FIG. 1a). A prior art magnification system such as described herein, will be used to assist him, by magnifying portions of the area of concentration 402. The portion of the area to be selection area 403 (FIG. 1a) will be defined, at any one time, by the position of the cursor 410 (FIG. 1a).

This selected portion of the image is then passed to a magnifier 13, which magnifies the portion of that image, providing a magnified image through a type of transformation. Image transformation, per se, may simply be a change of scale (zoom in), or it may be complex so as to preserve or improve image quality, but in any case it results in the presentation of a much larger image derived by directly magnifying the relatively small portion selected. The magnified image is then displayed, as exemplified in FIG. 1e, via an output device 14, such as a computer screen or a portion thereof, a purpose-built display, or a television screen or the like, to a visually impaired user 15, in an output area which occupies a portion of the display. User 15 is able to manipulate the magnified image, or to select a different portion of the original image, by using control 16 which may be a computer mouse, keyboard keys, touch screen or other. It will be noted that as the displayed magnified image includes only fragments of the information in which the user is interested, it requires constant repositioning in order to present to the entire area of interest.

The prior art system of FIGS. 1c and 1d suffers from various disadvantages which are caused by the nature of prior art magnification which is user controlled only with regard to the degree of magnification and dimensions of the output area.

A brief description of some of the prior art disadvantages is provided below, in non-limiting, illustrative examples only.

The magnified data may include:
A mixture of graphical and textual information, instead of focusing only on that which is specifically desired by the user, which may be either specifically graphics or text.
Data in which the user is interested as well as data in which he is not interested.
A fragment of textual information rendered incoherent due to relatively high magnification.
Unnecessarily magnified interface elements, such as buttons, menu items, separators and so on.

### DEFINITIONS

The following terms are used throughout the present specification as defined below, unless specifically stated otherwise:

The term “displayed data” is intended to mean any data displayed electronically that may be seen on a “data source” such as an electronic display screen, typically a computer or television screen, including electronically displayed text, web pages or other documents in a mark-up language or the like.

A “transformation hotspot” (also “THS”)—is a hotspot fully controlled by a user determining a portion of displayed data to be transformed and redisplayed. Typically, this is the location of a computer mouse cursor or other pointing device on the screen.

“Redisplay” refers to the display of data after transformation/reformatting thereof, in accordance with any of the embodiments of the present invention.

Various areas of the display are described herein with regard to the data that can be displayed.

Data intended to be read or otherwise viewed by a user with the assistance of an intelligent display system of the present invention is referred to herein as source data geometrically contained in an “available area.” The available area relates to the entire area occupied by the displayed data from which a portion to be reformatted for intelligent display can be selected. By way of example, this may be the full screen or a selected portion thereof. The user may select a portion of the available area from which he desires to read, this portion being known as an area of interest. The area of interest may thus include one or more of the following in whole and/or in part: the screen as a whole, a window, a list of articles, one or more images, separated articles, maps, graphs, drawings and so on.

An “area of concentration” is a portion of an area of interest which is selected by a user for reading, and may be, for example, a paragraph, sentence, image, table, graph, title, and so forth.

A “selection area” is a portion of an area of concentration which is directly presented to a user via one of any available output tools in accordance with the present invention. The selection area may contain a word, fragment of a sentence or image, several letters, a piece of a curve and so forth.

An “output area” is a geometrical portion of the screen where a user views the system output.

### SUMMARY OF THE INVENTION

The present invention seeks to overcome disadvantages of prior art by providing a system and method for facilitating enhanced use, particularly by a visually impaired user, with improved information perception, orientation, and navigation, with regard to the data which can be displayed on a display such as a computer or television screen, or any other type of digital display. Such data includes but is not limited to graphic, textual and contextual data. More preferably the system and method provide context-based orientational and navigational assistance to the user, in which the orientation and navigation is based at least partly upon the context within the data displayed.

Unless otherwise defined, all technical and scientific terms used above and herein have the same meaning as commonly understood by one of ordinary skill in the art to which this invention belongs. The materials, methods, and examples provided herein are illustrative only and not intended to be limiting.

There is thus provided, in accordance with an embodiment of the invention, an intelligent data display system which includes:

a complex data source for the storage and display on a visual display device of data of different types, including at least image data and text data;

two or more transformation channels for the extraction from the data source of data elements of a selected type and for the transformation of the extracted data elements into a selected display format including:
an image channel for the extraction and transformation of image data, and for the provision of transformed image data as a formatted image data output; and
a text channel for the extraction and transformation of text data, and for the provision of transformed text data as a formatted text data output; and

an output for receiving the formatted data output and for redisplaying it on the display device.

Additionally in accordance with an embodiment of the invention, the image and text data is displayed on the display device in an available area, and wherein system also includes a user operated selector for selecting displayed data from a user indicated area of concentration on the display device, smaller than the available area, for transformation and redisplay.

Additionally in accordance with an embodiment of the invention, the text channel is operative to extract text data from the area of concentration, and also includes a text organizer for identifying and removing non-textual elements such that only text elements remain within the extracted text data, and to connect together text elements separated by the removed non-textual elements.

Additionally in accordance with an embodiment of the invention, the text organizer is also operative to identify text elements lying outside the area of concentration, but forming part of the body of text lying within the area of concentration and contiguous therewith, and to connect together the contiguous text elements so as to form one or more contiguous portions of text for redisplay.

Additionally in accordance with an embodiment of the invention, the user operated selector includes a cursor indicating a specific location on the available area, and the at two or more transformation channels also include an orientation channel for determining the specific location of the cursor and for identifying a basic data element at that location, and further, for providing as output, orientation information for assisting the user in planning further steps with respect to the currently displayed data.

Additionally in accordance with an embodiment of the invention, the specific location of the cursor is selected from the following group:

the current geometrical location of the cursor; and

the current information location of the cursor.

Additionally in accordance with an embodiment of the invention, the orientation channel is also operative to determine the position of the specific location of the cursor relative to one of the following:

the currently displayed data; and

the available area.

Additionally in accordance with an embodiment of the invention, the orientation channel includes:

a locator for determining the presence of an element related to the basic data element, to be extracted when the cursor is positioned wherever; and

an extractor for extraction of the related element and its descriptors in response to a user request, as orientation data.

Additionally in accordance with an embodiment of the invention, the related element is of the type selected from the following list:

a data element that is geometrically related to the basic element; and

an element that is contextually related to the basic element in accordance with the position thereof in the hierarchical listing in the database.

Additionally in accordance with an embodiment of the invention, the orientation channel is also operative to provide the orientation data for display to a user on the display device.

Additionally in accordance with an embodiment of the invention, the orientation channel also includes a search director, for conducting a search for elements related to the basic element in accordance with user selected criteria.

Additionally in accordance with an embodiment of the invention, there is also provided a navigation channel for assisting a visually impaired user in navigating to any selected data element within the available area, wherein the navigation channel includes tools for constructing a database including a hierarchical listing of data in the data source.

Additionally in accordance with an embodiment of the invention, the tools for constructing a database include a compensator for updating the contents of the database in real time in response to small variations in the contents of the data source.

the complex data source includes a database containing a hierarchical listing of data in the data source also including a navigation channel for assisting a visually impaired in navigating to a desired data element which is selected from:

data elements located within the area of concentration and associated descriptors; and

data elements and associated descriptors located at a location within the available area, but outside of the area of concentration.

There is also provided, in accordance with a further embodiment of the invention, a method for the redisplay of a display of data of different types on a visual display device, including at least image data and text data, including the following steps:
extracting image data;
transforming the extracted image data;
providing the transformed image data as a formatted data output;
extracting text data;
transforming the extracted text data;
providing the transformed text data as a formatted data output;
redisplaying the formatted image data output and text data output on the display device.

Additionally in accordance with an embodiment of the invention, the image and text data is displayed on the display device in an available area, and wherein the method also includes the following steps, prior to the steps of extracting:

indicating an area of concentration on the display device, smaller than the available area; and

selecting data from the area of concentration a user indicated, for transformation and redisplay.

Additionally in accordance with an embodiment of the invention, the step of transforming the extracted text data from selected area includes the steps of:
extracting text data from the area of concentration;
identifying and removing non-textual elements such that only text elements remain within the extracted text data; and
connecting together text elements separated by the removed non-textual elements.

Additionally in accordance with an embodiment of the invention, the step of extracting text data from the area of concentration also includes:

identifying text elements lying outside the area of concentration, but forming part of the body of text lying within the area of concentration and contiguous therewith, and

connecting together the contiguous text elements so as to form one or more contiguous portions of text for redisplay.

Additionally in accordance with an embodiment of the invention, the step of indicating includes indicating by use of a cursor, and the method also includes the following steps:

determining the location of the cursor;

identifying a basic data element at that location; and

providing orientation information as an output, for assisting the user in planning further steps with respect to the currently displayed data.

Additionally in accordance with an embodiment of the invention, the step of determining the location of the cursor includes the step selected from the following group:

determining the current geometrical location of the cursor; and

determining the current information location of the cursor.

Additionally in accordance with an embodiment of the invention, the step of determining the location of the cursor also includes determining the position of the location of the relative to one of the following:

the currently displayed data; and

the available area.

Additionally in accordance with an embodiment of the invention, the step of determining the location of the cursor also includes the following steps:

determining the presence of an element related to the basic data element, to be extracted when the cursor is positioned wherever; and

extracting the related element and its descriptors in response to a user request, as orientation data.

Additionally in accordance with an embodiment of the invention, the data forms part of a data hierarchy, and in the step of determining, the related element is of the type selected from the following list:

a data element that is geometrically related to the basic element; and

an element that is contextually related to the element in accordance with the position thereof in the hierarchical listing in the database.

Additionally in accordance with an embodiment of the invention, in the step of determining, the related element is of the type selected from the following list:

data elements located within the area of concentration; and

data elements located from a location within the available area, but outside of the area of concentration.

Additionally in accordance with an embodiment of the invention, the method also includes the step of constructing a database including a hierarchical listing of data in the data source, so as to assist a visually impaired user in navigating to any selected data element within the available area.

Additionally in accordance with an embodiment of the invention, the method also includes**** the step of updating the contents of the database in real time so as to compensate for small variations in the contents of the data source.

### BRIEF DESCRIPTION OF THE DRAWINGS

The invention is herein described, by way of example only, with reference to the accompanying drawings. It is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

FIG. 1a is a screen shot of a typical website, showing an area to be magnified;

FIG. 1b shows the portion of FIG. 1a to be magnified in accordance with the prior art;

FIG. 1c is a top level block diagram of an exemplary prior art system for assisting visually impaired readers;

FIG. 1d is a more detailed representation of the system of FIG. 1c;

FIG. 1e shows the selected portion of FIG. 1a, after magnification with the prior art system of FIGS. 1b and 1c;

FIG. 2a is a top level block diagram of an intelligent display system constructed in accordance with an embodiment of the present invention, which includes separate transformation channels for images and for text;

FIG. 2b is a more detailed view of FIG. 2a;

FIG. 3 illustrates the system of FIGS. 2a and 2b, but also having, in the text transformation branch, an element for significantly improving text perception by a visually impaired user according to at least some optional embodiments of the present invention;

FIGS. 4a-4c demonstrate results of intelligent text transformation in accordance with the present invention;

FIGS. 5a-5c demonstrate further results of intelligent text transformation in accordance with the present invention;

FIG. 6 is a detailed flow chart showing operation of the system of FIG. 3;

FIG. 7 is a block diagram illustrating a modified system including an orientation channel, in accordance with a further embodiment of the present invention;

FIG. 8a is a more detailed view of the orientation channel of the system of FIG. 7;

FIG. 8b is further modified version of the system of FIGS. 7 and 8a;

FIG. 9 is detailed flow chart showing operation of the orientation channel of the system of FIG. 8b;

FIG. 10 illustrates different options of searching capabilities by use of the orientation channel;

FIG. 11 illustrates a further modified system, including navigation capabilities, in accordance with yet a further embodiment of the present invention;

FIG. 12 details the structure of the navigation channel of the system of FIG. 11;

FIG. 13 shows a portion of the navigation channel in detail;

FIG. 14 details the structure of the data organizer from the navigation channel of FIG. 12;

FIGS. 15a-15c demonstrate several examples of on-screen elements which can be filtered by exclusion from the database or deletion therefrom, thereby to improve the navigation process;

FIGS. 16a-16b illustrate erasing “meaningless” data elements further improving navigation capabilities (as shown in FIG. 16a) or demonstrates the use of an algorithm for the filtering of “empty” on-screen areas and the logic of navigation without them (as shown in FIG. 16b);

FIG. 17 demonstrates the navigation process when excluding large empty areas located within text blocks;

FIGS. 18a-18c presents an example of an extracted contextual element which is not useful for navigation. FIG. 18a demonstrates a fragment of the MS Word® application. A software tool based on MS UTA library applied to location 951 (FIG. 18a) outputs hierarchical information for the element “Custom”; this chain is shown in FIG. 18b. the table determining hierarchical chain for the indicated location stored in the data base will look as it is shown in FIG. 18c;

FIGS. 19a-19d show examples of geometrical grouping of different elements to improve navigation capabilities;

FIG. 20a illustrates a typical screen display having a number of different Windows system elements;

FIG. 20b is a diagrammatic illustration showing the hierarchy of the elements seen in the screen display of FIG. 20a;

FIG. 20c shows basic navigation directions from one data object to an object that is adjacent in the hierarchy;

FIG. 20d shows two navigation examples within the hierarchy of FIG. 20b;

FIG. 21 illustrates the system of FIG. 11 but with the addition of a compensator for small data variations; and

FIG. 22 details the structure of the compensator seen in FIG. 21.

### DETAILED DESCRIPTION OF THE INVENTION

The present invention provides a system and method for assisting a visually impaired user with perception, orientation and typically also navigation with regard to data which may be displayed on a digital display, such as on a computer screen. It will be appreciated that while the present invention is exemplified with regard to a rectangular screen display, it is clearly applicable to displays of all shapes and sizes, including round, oval, polygonal and others. In accordance with certain embodiments described herein below, the system and method provide content-based navigational assistance to the user, in which the navigation is based at least partly on the content of the displayed data.

It will be appreciated by persons skilled in the art that the present invention possesses a number of advantages when compared with the prior art, including:

Beyond the basic functions of data selection and transformation, the present invention optionally includes orientation and navigation by the user.

In order to provide more transformed data in an intelligent manner, the present invention has an output area that is able to obscure less of the screen than the prior art, such that there remains a greater visible area which, in accordance with the degree of impairment of the user, can be used for orientation and navigation.

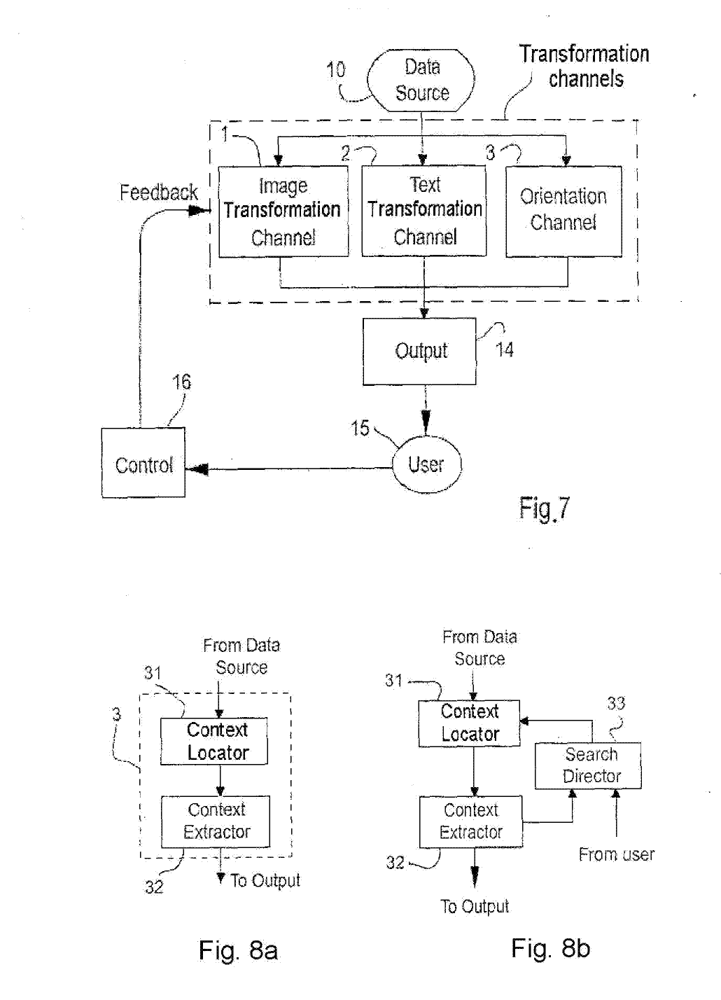

It will however be appreciated, that with the provision of orientation and navigation data as described hereinbelow in conjunction with FIGS. 7-22, the output area may alternatively be enlarged to fill virtually the entire screen, while ensuring that the user retains at all times a sense of orientation and an ability to navigate to other portions of the computer system.

The present invention thus provides redisplay of data to the user, which is distinct from and is a significant improvement to the prior art, by the analysis and collection of maximum amount of relevant data, and transformations of the data and/or the output area prior to redisplaying the selected data. This not only optimizes the use of that data for redisplay, but also facilitates the provision of orientation and navigation capabilities.

For the purposes of the present description, it is convenient to relate to displayed data as being composed of objects or elements which are graphic, text, and substance- or context-related. It should be noted that this classification is for convenience only with regard to the present description, and other classifications may be equally valid. It will be appreciated that all of these objects or elements can be successfully used for orientation and navigation, as described hereinbelow.

In use, the above-listed objects are defined as follows:

Graphic objects: objects having stable or mobile graphic representation. Non-limiting examples include graphs, drawings, charts, diagrams, pictures, graphic separators, objects frames, animations, movies, flashes, etc. Among them are objects which may contain some textual information which may or may not be extractable by Optical Character Recognition (OCR) software as known in the art. They also may be hyperlinks referring to other objects, locations or websites, etc. Objects which are both graphic and textual, are known as dual purpose objects.

Text objects: portions of text capable of transformation to a set of machine readable symbols. Non-limiting examples include articles, paragraphs, sentences, words, etc. Text objects may also be presented in a graphic form. Non-limiting examples include PDF files, inscriptions in graphs and drawings, etc. For navigation purposes these objects may also require the additional step of OCR. Text objects also may be hyperlinks, serving as another example of a dual purpose object.

Substance or context related objects: objects whose functions are not only to show the information but also to suggest or permit certain actions by a user leading to a change of the displayed data in some way. Non-limiting examples of such objects include buttons, menu items, and scrolling elements, and examples of their functions may include tasks such as activation of a menu item, opening of a file, running an application, opening a dialog box, refreshing the screen, switching to a different website, and so on.

Such classification of objects is useful in the construction and organization of a database for storing the screen contents, and which assists with user orientation and/or navigational assistance, which may be provided either in response to a user request and/or automatically.

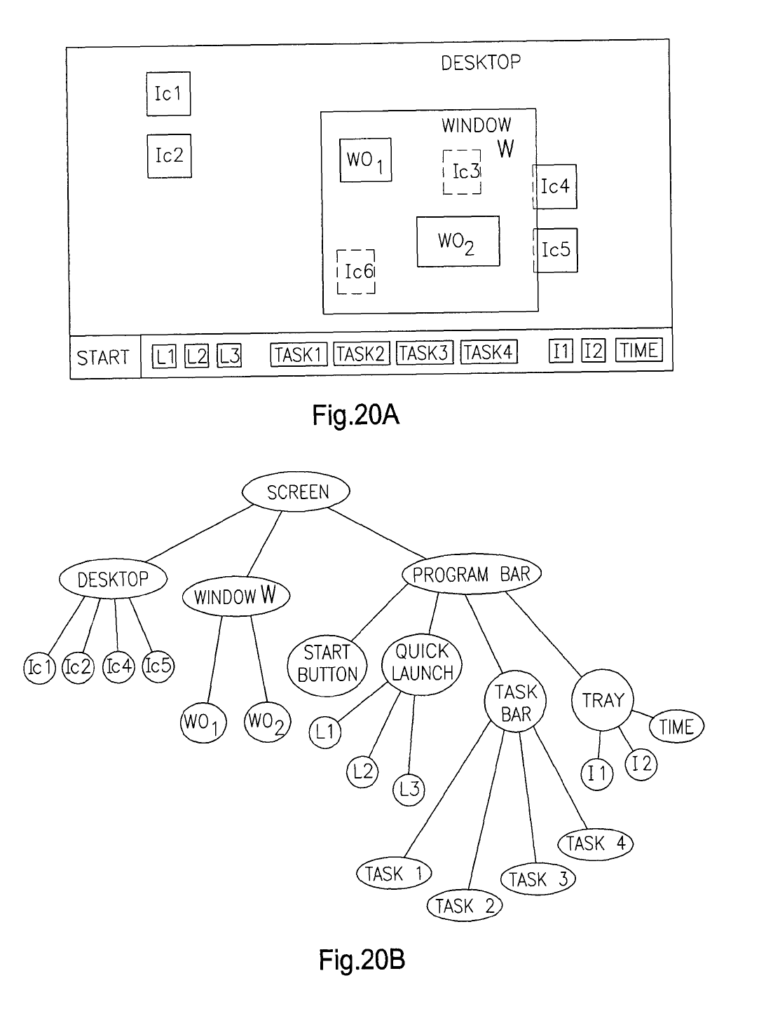

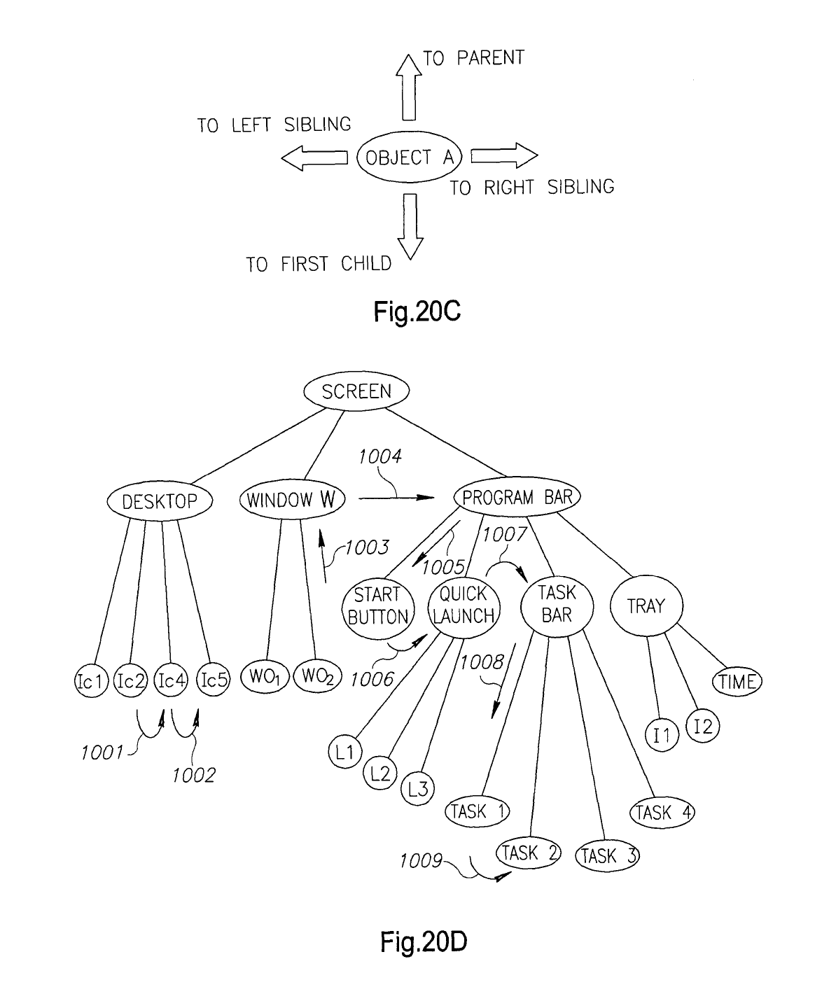

This classification is not absolute, however, because, as with hyperlinks which may be dual purpose, having graphic and text features, there are different objects which can relate to a number of different classes. For example, many objects are visible both graphically and textually; a push button, for example, has a colored rectangular shape with a text name and a caption. Pictures may also be links; links may have meaningful content, such as text, and so forth. Objects of such types will appear in several parts of a database described below in conjunction with FIGS. 20a and 20b.

As will be appreciated from the ensuing description, the present invention is operative to analyze the data selected by a user for redisplay, and to process and store (a) textual data, (b) substantial/contextual data and (c) other relevant data of all types so as to afford the user many different possibilities in his use of the redisplayed data, according to various embodiments of the present invention.

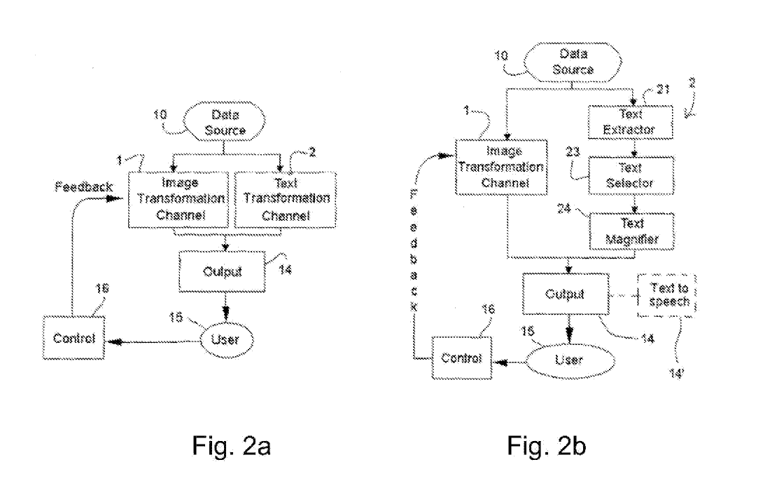

Referring now to FIGS. 2a and 2b, there is shown an intelligent display system in accordance with an embodiment of the present invention, which reformats selected text so as to make it more readable for visually impaired users. As seen in the drawings, this may be achieved by the provision of an image transformation channel 1 and a separate text transformation channel 2.

Referring now to FIG. 2b, text transformation channel 2 includes a text extractor 21 for the extraction of textual information from all or part of the area of interest, as described in greater detail below. Channel 2 further includes a text selector 23 and text transformer 24. The text selector is controlled by the user to determine an exact portion of extracted text for transformation in text transformer 24 and display via output device 14 as reformatted text, typically enlarged for easier viewing, and for optional presentation to the user in audio form with use of a text-to-speech engine, referenced 14′.

These two operations, namely text extraction and selection, can alternatively be performed in reverse order such that the selector 23 is used to specify a desired portion of text from the area of interest and then the text extractor 21 extracts a limited amount of the text for reformatting.

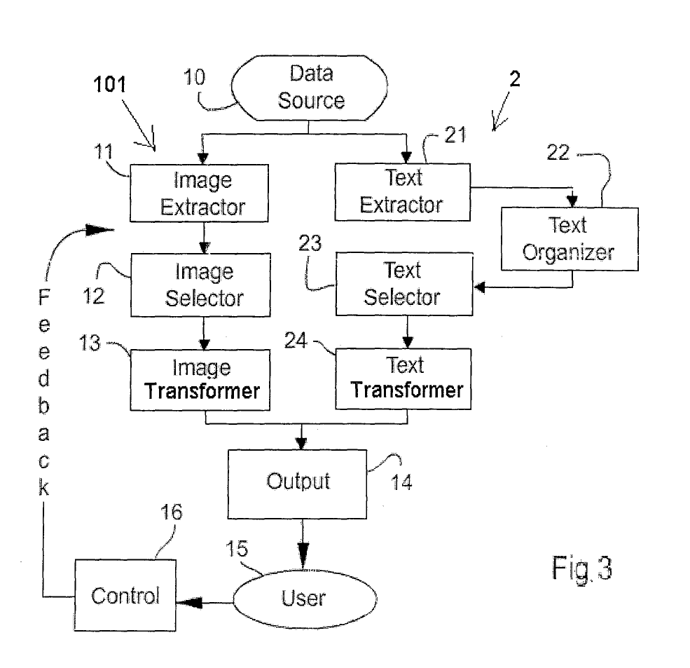

Referring now to FIG. 3, there is shown an exemplary system, constructed and operative in accordance with at least some embodiments of the present invention. The system is similar to that shown in FIG. 2b, but also including a text organizer 22 in text transformation channel 2.

Text extractor 21 in the illustrated system FIG. 3 preferably performs “contextual” extraction of text, in order to extract from the area of concentration a significant portion of connected text, preferably as long as possible, and with all of the location data associated with the text, including but not limited to coordinates of line beginnings and ends, coordinates of THS, cursor position, caret, and so on. Software tools for achieving this are well known, and so they are not described in detail herein. Several examples of so-called ‘Word/Text Capture’ software tools are available on the internet, for example, those listed at the website http://word-capture.qarchive.org. The output of such text extraction tools is a set of text fragments, as the text is divided up by a number of apparently non-textual elements, such as links, images, lines, bullets and so on.

Text organizer 22 is operative to connect the text fragments. Several illustrative, non-limiting rules by which text organizer 22 handles the construction of connected or continuous text from separated text fragments include:
a) An embedded link inside a text is considered to be part of the text.
b) A small image embedded in text is not part of the text and does not interrupt it.
c) Two paragraphs separated with only one empty line are optionally treated as continuous text, depending on a user selected preference.
d) Bullets and or numbering do not interrupt the continuity of a text.
e) The font, style, color and size of symbols do not interrupt the continuity of a text.

This list of rules may optionally be expanded and/or adjusted for the specific needs of a user.

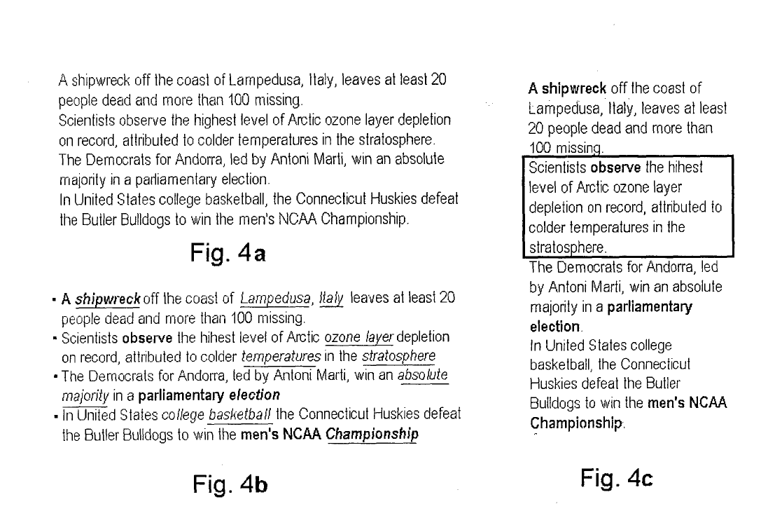

The output of the text extractor 21 is a sequence of symbols with detailed location data, which is provided to text organizer 22 which transforms this data by organizing it into a form that is the most appropriate for the user 15 and/or according to the requirements and limitations of output means 14. Examples of the output are shown and described in conjunction with FIGS. 4a-4c, below.

Once the organized text is received via text organizer 22 and text selector 23, it is reformatted by text transformer 24. Methods for transforming text, per se, are well known in the art, for example by reducing or increasing the font point size and/or by changing fonts, all of which can easily be performed by software as is known in the art.

It is important to stress that while in the prior art, magnification of text employs the same principle as for graphics magnification, namely, only geometrical magnification of a selected portion of the area of concentration; in the present invention it is the selected text object specifically, that is reformatted, either wholly or partially. This is exemplified hereinbelow in conjunction with FIGS. 4a-4c.

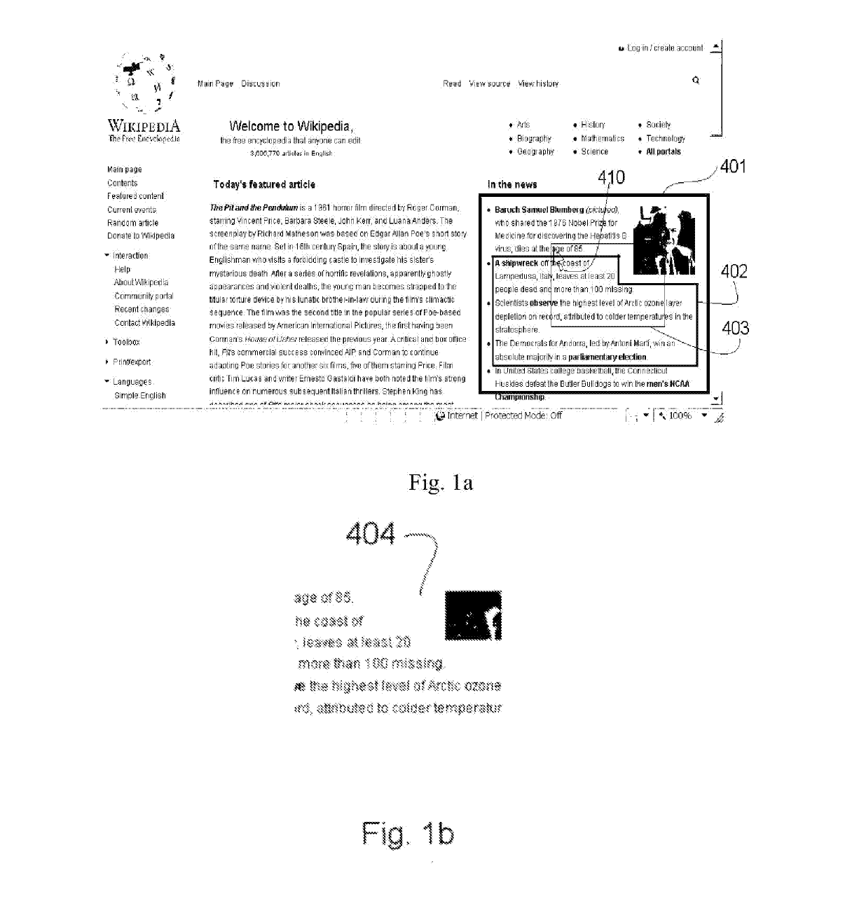

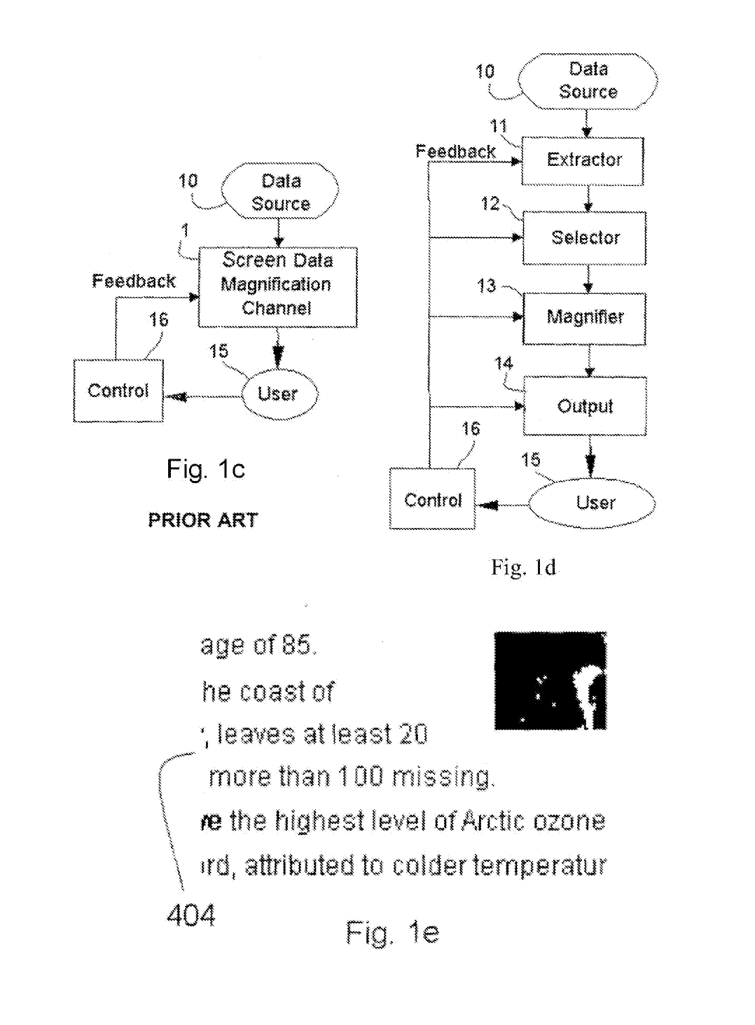

Referring now generally to FIGS. 4a-4c, it will be appreciated by persons skilled in the art that there is a significant difference between magnification according to the prior art, described in conjunction with FIGS. 1c and 1d above, on the one hand, and redisplay in accordance with the present invention, described in conjunction with FIGS. 4a-4c, on the other hand. In accordance with the present invention, the text as reformatted and displayed by use of intelligent display system 101 (FIG. 3), as seen in FIGS. 4a-4c, is complete and is easy to read.

Referring now to FIG. 4a, there is shown a portion of text which is extracted via the text transformation channel 2 (FIGS. 2a, 2b and 3), with use of the text organizer 22 (FIG. 3), in which the text is organized in a manner which is generally similar to that of the original screen image (FIG. 1a). In the present invention, the position of the THS does not indicate an area of the display to be redisplayed, per se, but one or more text object(s) to be redisplayed, even if they are not completely included within the area 403 (FIG. 1a). Accordingly, every text object thus indicated, from its beginning to its end and which forms a complete object, is processed and reorganized according to preselected requirements of the user, and is displayed in a manner which facilitates viewing of the text, and navigation within the text. The navigation may, by way of example, be achieved through one directional (horizontal or vertical) scrolling of the output text through the output area. In this manner, the danger of the user losing the relative location in the line or between lines is decreased. It is also easier to jump to the next/previous line, as the immediate continuation of each line at the beginning of the next line is always visible.

FIG. 4b shows another manner for text organization which differs from that shown and described in conjunction with FIG. 4a by preserving some of the original formatting features (font type, font size, and so on), and some of the functional features (title, article text, hyperlink, others), bullets, numbering, and so on.

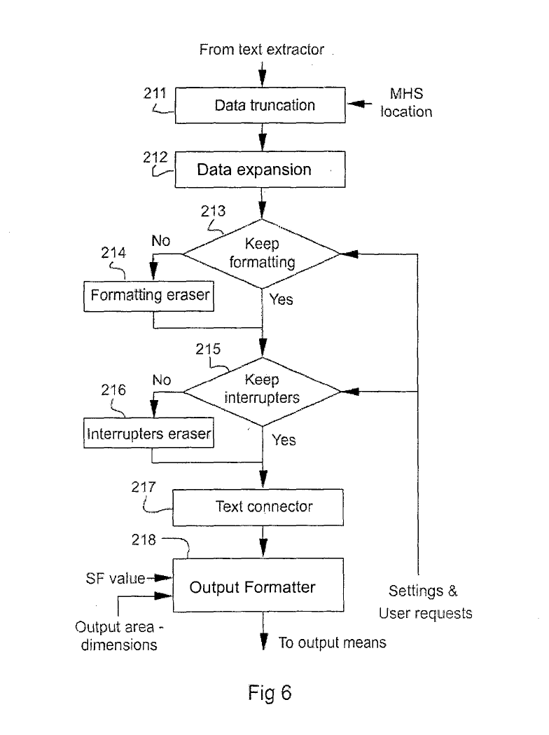

Another difference from the output of FIG. 4a is that in accordance with an alternative embodiment of the invention, the system may include different algorithms and methods for output organization, such as maintaining continuity of headers, hyperlinks, and bookmarks, etc, such as described hereinabove in conjunction with FIG. 3 and hereinbelow in conjunction with FIG. 6. Also, in the present example, in-line hypertext (or mark-up language) may be maintained and shown more clearly, for example through underlining or other visual markers. In the present example, italicized, bolded text is used to indicate hyperlinks

In a situation in which the available output area is of limited dimensions, and the selected or permitted scale factor cannot be reduced beyond a predetermined minimum for a particular user, problems may be encountered when displaying the text. Clearly, the smaller the output area and the bigger the scale factor, the less text can be displayed, and more navigation commands must be input by the user, e.g. to scroll to the end of the displayed text.

In order to overcome this problem and as seen in FIG. 4c, there is shown an alternative form of presentation of the text in the style of a newspaper article, which may be applicable when the output area is of limited width, and in which the extracted text has been reorganized to correspond to the selected scale factor and available output area. This provides a reading mode in which the user is simply required to scroll vertically within the article inside the output area.

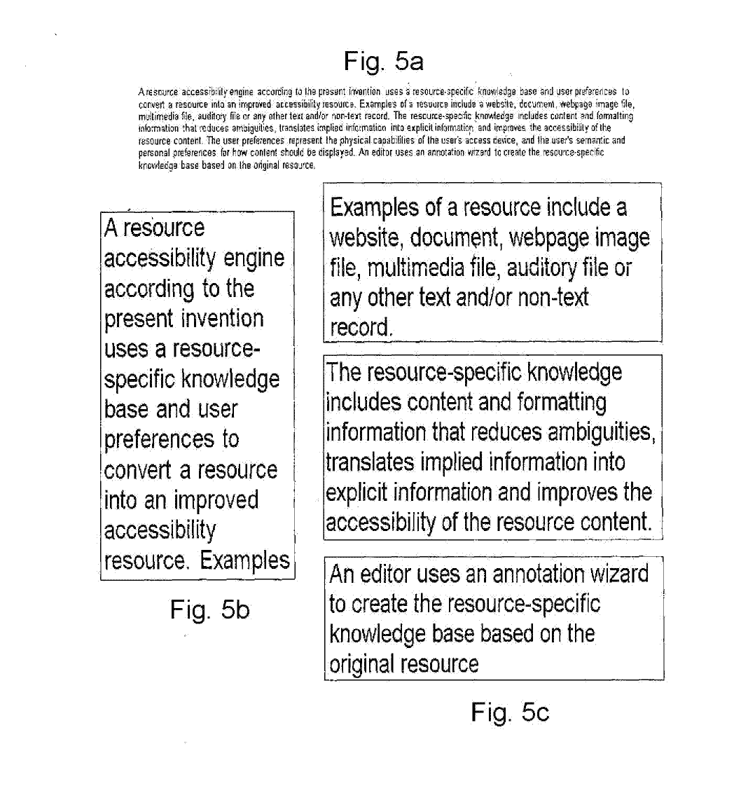

As exemplified in FIGS. 5a-5c, there also exist other possible ways for text organizer 22 to optimally reformat text for display. Specifically, this includes reformatting and adjustment of the output area in such a way that only vertical scroll is necessary for reading and editing the text. This also significantly improves navigation abilities within the text, limiting movement therewithin to vertical scroll only.

FIG. 5a shows the original text.

FIG. 5b shows reformatting of the original text to fit an output area of predetermined dimensions, such that the entire text can be viewed by vertical scrolling only.

FIG. 5c shows consecutive outputs of the same text sentence-by-sentence (only the 2nd, 3rd and 5th sentences are shown) wherein the output area is adjusted automatically for each sentence in order to accommodate the height of the text displayed.

Referring now to FIG. 6, there is shown a flow chart representation of an algorithm implementing text reorganization as described in conjunction with FIGS. 4a-5c. The following description of this algorithm refers to areas which are shown in FIG. 1a.

Initially, text extractor 21 (FIGS. 2b and 3) extracts a full set of information regarding text data from area of interest 401 (FIG. 1a); this includes text symbols, location data, formatting data and objects interrupting text continuity. By moving the cursor 410 (FIG. 1a) the user then positions THS somewhere inside area of concentration 402 so as to indicate selection area 403.

As seen in the flowchart of FIG. 6, as a first step in the processing text, the text is truncated in step 211, by initial deletion of all text objects which are outside of area 403. However, the selected text data is subsequently expanded beyond area 403, as indicated by step 212 so as to include the text which is outside of area 403 but which contextually, location-wise and syntactically appears to be connected to the text inside the area 402. Thus, the resulting data includes a full set of text data regarding the text from the entire area of concentration 402.

The subsequent parts of the algorithm prepare existing data for output according to predetermined settings and user requirements. Step 213 optionally deletes formatting in formatting eraser 214. Format erasing will result in the ultimately displayed text to take on the appearance of the minimally formatted text as exemplified in FIG. 4a. If no format erasing is performed, then the output will be substantially as illustrated in either of FIG. 4b or 4c.

The data is then provided to a process at block 215 which, depending on settings and user requirements, directs the data either to preparation for output or for erasing of interrupters from text (organizing of continuously connected text fragments), as described hereinabove in conjunction with FIG. 3. Prepared in such a way, text fragments are connected in continuous portions by text connector 217. In a final formatting of the text for output in output formatter 218, the text will be displayed in accordance with predetermined settings including scale factor, seen as the “SF value” prompt (FIG. 6), dimensions of the output area and any user specific requirements.

Methods and algorithms for these types of text organization are known to be used in different text editors, for example, Microsoft® Word® and Excel®, and are thus not described herein in detail.

A major disadvantage of the prior art systems is that they lack effective orientation capabilities, so the user can easily become disoriented or ‘lose’ data that he/she is currently viewing. Furthermore, for more complicated reading material, such as a book or large extended document, or a document that is not necessarily large but contains a lot of different information as, for example, a news website, orientation becomes critical, as otherwise the user cannot effectively perceive the material displayed.

Orientation may be defined as a complex process having a specific goal, consisting of several sub-processes.

In the context of the present invention, the goal of orientation is the determination of the current geometrical and/or informational location of a THS and the position of its location relative to the currently displayed data and/or the available area. Once the user is oriented, it is then possible for him to plan his next steps with respect to the currently displayed data.

An example of an achieved orientation goal may be as in the following scenario, in which, for example, the menu bar of an MS-Word®2003 application window has, inter alia, the following items, listed from left to right: File, Edit, View, Insert. If the THS, which is the present example is the cursor, is over the item captioned “File” it is the first item in the menu and thus has no “neighbor” or “sibling” item; but it has to its right, a neighbor or sibling item captioned “Edit”. The menu item is not active (i.e. the user has to use a mouse or other pointing device to activate it) but the window is active.

In this scenario, the orientation task for the user may optionally include the following sub-tasks:
Determination of the type of object or element, and all other data associated therewith, such as, where relevant, its contents, function and so on;
Determination of the geometrical location of the element with a predetermined degree of accuracy (pixel, centimeter, quarter of visible area, to the top-right direction from a button, and so forth);

Determination of the current status of the element, namely, whether it is currently active so as to be selectable, or not; if it is selectable, whether or not it has been selected; whether it is focusable, for example, when the cursor is over a service item in MS Word® and the item changes its appearance—it is considered to be “focusable”.

There are different reasons for a loss of user orientation in relation to magnified data, such as in the prior art. One of them is the situation in which the whole currently selection area is empty. Such a situation is typical, especially when magnifying by use of relatively large scale factors, for technical or art materials, for websites, books and so on.

Another source of significant problems is the nature of the operations “zoom in” and “zoom out”; often, due to even slight movements of THS, zooming back in to a point will result in the display of a different portion of text or a different location, for example, on a map, than expected or desired. For visually impaired users this can be particularly problematic, and can lead to a loss of orientation.

Additional problems in orientation may occur when the contents of the data source changes significantly. Typical examples of large changes are upon the opening of a new window, the appearance of a new dialog box, a change in the active web page, a change in the visible page of a document, a change in the zoom factor, and the like.

Referring now to FIG. 7, in accordance with am embodiment of the invention, there is provided an intelligent display system which is similar to those shown and described above in conjunction with FIGS. 2a-6, but also including an orientation channel, referenced 3, so as to provide the current

geometrical location of the selection area or THS in linear measurements (pixels, centimeters, etc) relative to an “origin”, for example, top-left corner of the screen and/or

informational location of the selection area or THS, i.e. its positioning in relation to the currently available information neighborhood and more specifically—in relation to its closest neighbors, for example data elements to its left and right, above it, and below it.

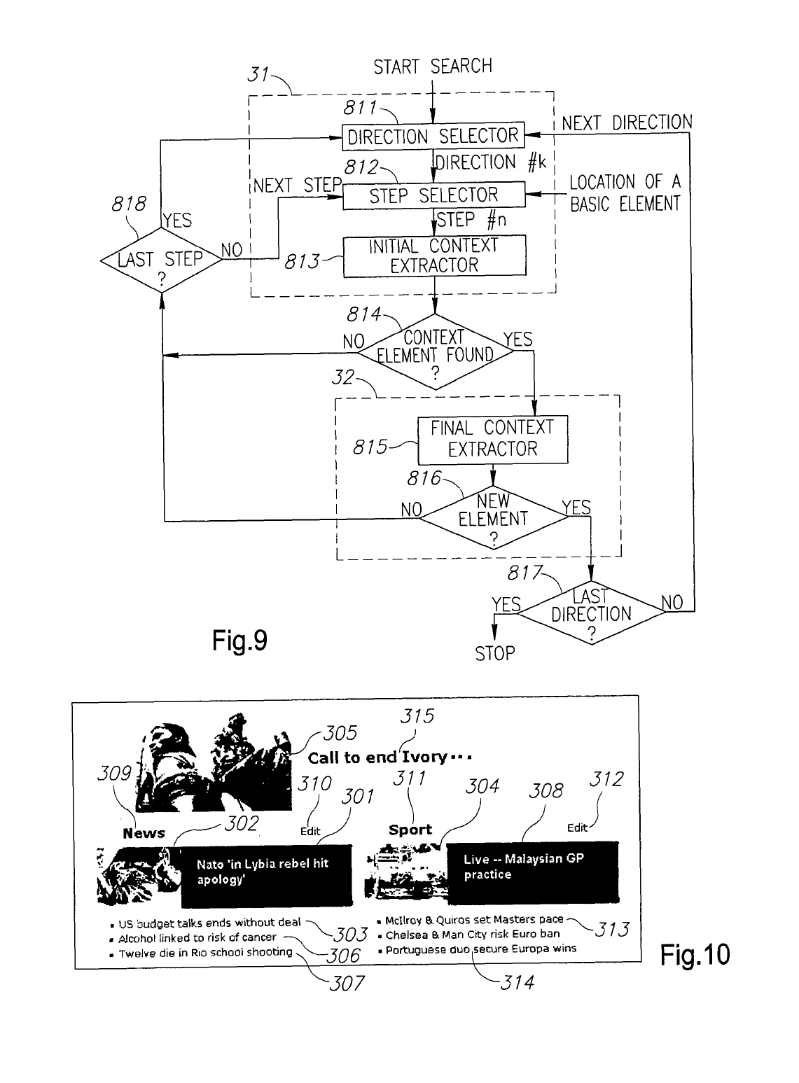

As seen in FIG. 8a, the orientation channel 3 includes two basic components, namely, a context locator 31 and a context extractor 32. As described below in conjunction with FIG. 9, context locator 31 determines the presence of a contextual object or element to be extracted, when the THS is positioned thereover. Subsequently, the context extractor 32 is operative to extract the object or element in response to a user request.

Software serving for the implementation of context extraction functions is widely used in different screen readers, and special Application Programming Interfaces (API) are created for facilitating the extraction process. Well known examples of such APIs are MSAA (Microsoft Active Accessibility) and a version thereof User Interface Automation (UTA). This allows extraction of a set of descriptors for a desired object (name, type, location, current status, and so on).

The output from orientation channel 3 may be presented to the user in an enlarged textual form or in audible form, and includes a list of descriptors, including the name, type and location of the object, with additional optional descriptors as per user request or preset. The user is able to control the content and specific form of this output by use of control 16.

The provision of such locational and/or contextual information in response to a user request facilitates user orientation, due to the fact that each location at which the THS is positioned has associated therewith a large amount of information.

Further development of this approach provides useful tools for the further improvement of orientation capabilities and for the provision of navigation in close locational and/or contextual neighborhood, as seen in FIG. 8b. This embodiment employs the provision of contextual information about contextually neighboring objects for a selected THS location.

The term “substance or context related objects” is defined hereinabove. With regard to the term “contextual neighborhood” as used in the present description, for any contextual object within the data source it is intended that:
There is at least one context related object within data presented in a data source
A contextual object currently selected by the THS, is a “basic” object.
A basic object may have several contextual neighbors.

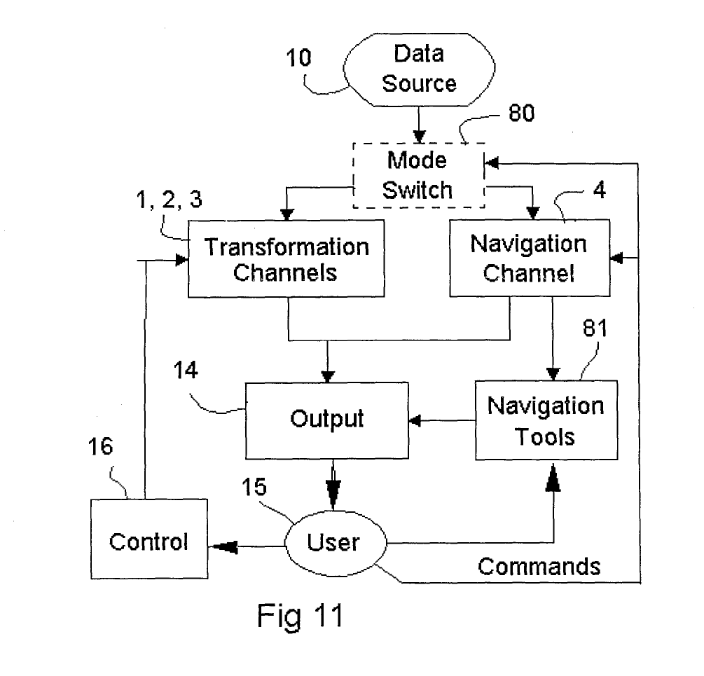

In the present embodiment, it is useful to consider two types of contextual neighborhoods, namely, a geometrical neighborhood and a contextual neighborhood.
a. A geometrical neighborhood is a neighborhood in which a neighbor is close to the basic object distance-wise.
b. A contextual neighborhood is one wherein an object is close to a basic object contextually by hierarchical connection, namely, being a sibling, parent or child of the basic object. The hierarchical relations are described hereinbelow in greater detail in conjunction with FIGS. 11 and 20a-d.

In a further development of orientation capabilities which is required so as to facilitate navigation in a close neighborhood of the basic object, a search director 33 is added into the orientation channel 3, as shown in FIG. 8b. Search director 33 is operative, in response to a user request, to initialize a search for the closest geographical or contextual neighbors for an object currently selected by THS, namely, the basic object for the purpose of this search. Search director 33 provides to context locator 31 a new location to be checked for the existence of a new contextual object. Upon identifying a new contextual object, context extractor 32 extracts descriptors of thereof, allowing the search director 33 to initiate a search for a further neighboring object. After extraction of the descriptors of a new object the search director 33 classifies the object as a contextual or geometrical neighbor and assigns a correspondent value to a correspondent parameter.

By way of example, if the type of basic selected object is a hyperlink, then all hyperlinks discovered in the search neighborhood are contextual neighbors; and all elements of other types such as menu items, buttons, headers, and so on are geometrical neighbors.

An exemplary flow chart of a suitable search algorithm for the implementation of the search director 33 is shown in FIG. 9.

Initially, upon receiving a user request as a command “Start search” a direction selector 811 initiates a search along one of possible directions for example to the right of the basic element.

A step selector 812, starting from a known location of the basic element performs a series of steps each of a predetermined number of pixels; thus determining certain coordinates of a point to be checked by initial context extractor 813 for the presence of a contextual element. If a potential neighbor element is found, as determined in block 814, a final context extractor 815 extracts descriptors of the discovered element which are compared in block 816 with those for previously found elements. If the element is new, namely, it was not previously found, it is considered as a discovered neighbor. If this element is of the same contextual type as the basic element, it is considered as contextual neighbor; otherwise it is geometrical neighbor. A check is then performed along the same direction, as per step 817, as to whether all desired directions have been tested, in which case the process is stopped; otherwise the process continues at direction selector 811 so as to search in other directions.

If no element is found in a specific location or if the element located is not new, the possibility of continuing the search by making one more step in the same direction is checked, as seen in block 818. This process may be interrupted by user, although it will in any case be interrupted upon reaching of a boundary, such as the edge of the screen, window, dialog box and so on. The process may also be interrupted when reaching a limit that has been preset by the user, based on a maximum number of steps or maximum time period. Another criterion for stopping this process can be discovering the object closest to the basic object in each of a plurality of preset directions. Other criteria may also be applicable.

The number of directions for such a search can be one of a number of parameters entered by a user during system installation; or before or during a working session. One search option is four orthogonal directions, namely, left, up, right and down relative to the area of interest, although others may also be provided.

In accordance with a preferred embodiment of this invention there are implemented both geometrical and contextual searches for neighbors.

FIG. 10 shows one example of a search along four directions: left, up, right and down for an exemplary website presented in black and white versions. Starting from a basic text link 301 “Nato ‘in Lybia . . . ’ the following closest neighbors will be found:
to the left—an image-link 302 with the same description as th text link;
to the bottom—text link 303 “US budget . . . ”
down—image-link 304 with sub-text “Live—Malaysian . . . ”
up—another image link 305 with sub-text “Call to end Ivory . . . ”.

In this example, only one “pure” contextual neighbor 303 has been found for the text link 301. Three others are simultaneously both contextual (hyperlinks) and geometrical neighbors. This situation is typical for the home pages of many internet news sites.

With further reference to FIG. 10, it is noted that when seeking not only the closest neighbors, there will be found additional objects, including those referenced 306, 307, 308 and 309. But in order to find objects 310-315 which are not in the four mutually orthogonal directions mentioned above, it is necessary to expand the search, in additional directions.

It will thus be appreciated that when the user has information both about the current contextual object indicated by the THS and also about several neighboring objects, he possesses sufficient data to orient himself, and is able to navigate to one of these neighbors if he so desires. This possibility significantly assists the user in perception of the available information. An increase in the number of available search directions expands navigation capabilities, while slightly increasing complexity of the above-described algorithm and/or slightly slowing down the search process.

Navigation as described above is performed with regard to objects that are generally locally or contextually close in nature or type to the basic object.

Referring now to FIG. 11, there is shown a schematic block diagram of an exemplary embodiment of visually assistive system architecture constructed and operative in accordance with an embodiment of the present invention, to provide further improved navigational capabilities within the entire available area. The system presented in FIG. 11 is generally similar to those shown and described above in conjunction with FIGS. 2, 3 and 7, but with the addition of a navigation channel 4. For purposes of conciseness, image transformation channel 1, text transformation channel 2, and orientation channel 3 are represented by a single block, referred to herein as transformation channels 1, 2, 3.

In the present embodiment “Navigation” is defined as a complex process having a specific goal and consisting of several sub-processes. The overall goal relates to movement of the THS by a user, from its current location, determined during orientation as above, to a desired location relative to its geometrical and contextual environment for the viewing of required data.

Unless stated otherwise, specifically, the term “current location” is used herein to mean the location of the THS.

The process of navigation preferably includes the following sub-processes:
i. Orientation, i.e. determination of the current location based on geometry and/or context, as defined hereinabove.
ii. Selection of a target. This differs depending on whether the navigation process is a geometrical process or a contextual/data-related process. In the case of geometrical navigation a user selects the target with regard solely to its geometrical location relative to the current location, such as from the current cursor location to the North-East, or to the lower-left corner of the application window, for example. In the case of contextual/data-related navigation, the user searches for an element based on its context, regardless of its geographical location.
iii. Planning of a path from the current location to the target location and/or element.
iv. Implementation of a maneuver so as to move the cursor to the target location and/or element.

In general, navigation channel 4 is operative to extract all of the data contained within the data source 10, to process the data, and to store it for use when required.

In more detail, navigation channel 4 is operative to perform the following operations:
1. Collection of the entire body of data from the entire available area.
2. Analysis of the collected data and classification elements/objects with their descriptors.
3. Construction of the hierarchical structure of the extracted data.
4. Storing the extracted data and its hierarchical structure.
5. Monitoring changes in the extracted data and its constituent portions in real time with the purpose of possible compensation for such changes.
6. Providing to the user information as required.
7. Signaling to the user about significant changes in available data.
8. Acceptance, interpretation and execution of the user's navigation commands.

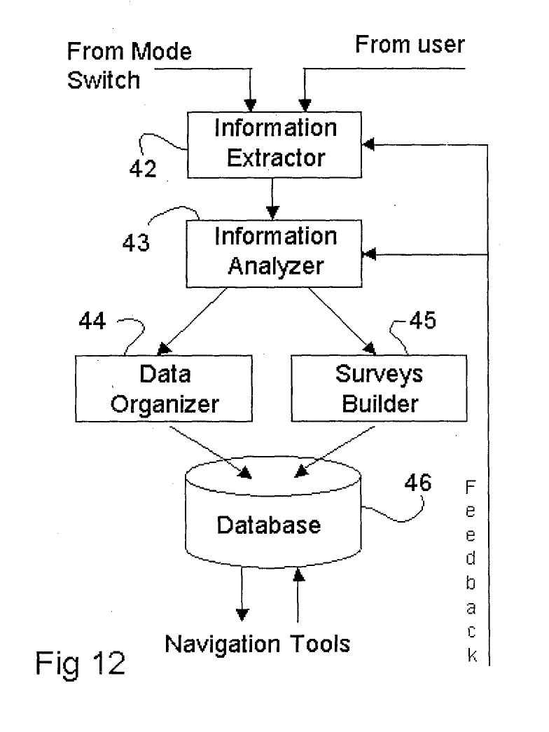

Reference is now made to FIG. 12. The presence of the extracting and analyzing components, respectively referenced 42 and 43 in FIG. 12, is a fundamental difference between the navigation channel 4 and the transformation channels 1, 2, 3 described above. The reason for these differences is due to the fact that navigation channel 4 employs all of the data within data source 10 so as to provide more powerful navigation options, as opposed to the more limited, local navigation afforded by the system of FIG. 7.

The system shown in FIG. 11 operates as follows:

Mode Switch 80 is operative to switch the system to either transformation mode or navigation mode. Alternatively, with sufficient computational power the system can be configured so that information from data source 10 is simultaneously available to both the transformation channels 1, 2, 3 and the navigation 4 channel working in parallel, such that a mode switch is not required.

When the system is initially activated, navigation channel 4 starts collecting of all existing data from the available area. This process can also be activated either by the user or automatically so as to renew an existing database of stored data. When the process of data collection, processing and storage is finished, a predetermined signal is provided to the user, after which he selects either:
Transformation channels 1, 2, 3 for operation with a specific piece or type of information; or
Navigation (channel 4) in order to navigate to a subsequent portion of data or in order to execute a specific navigation command.

Output from navigation channel 4 is provided to navigation tools 81 used by user for navigating.

The navigation channel 4, shown in detail in FIG. 12, preferably includes the following components: an information extractor 42, an information analyzer 43, a data organizer 44, a survey builder 45 and a database 46. Their interrelation and functions will be understood from the following description.

The process of collecting data from the available area by the information extractor 42, is initiated either via mode switch 80 (FIG. 12), or automatically, in response to a significant change in the display, as described hereinbelow.

The data collection process preferably occurs automatically whenever the available area changes. By way of non-limiting example, this may be when first turning on the system; when the display screen is refreshed; when a new application window is opened; or when a dialog box is opened.

As mentioned above, the data collection process can also be initiated by the user. This may be done, for example, after a change in the contents of the data source, such as when opening an additional web page or dialog box; after entry of a PageDown command; and so on.

At this time, information extractor 42 immediately starts scanning the data source, extracting and collecting all the available data, including all the different data components together with their descriptors as described above in conjunction with FIG. 6

Information extractor 42 implements a process of extraction of data from the available area based on known software tools, such as APIs, specifically constructed for such information extraction procedures, for example, the Microsoft products MSAA and UTA, as mentioned above. This process may be organized such that the display is scanned geometrically with a predetermined discretization step point by point and the extraction of an object or element located at each point, with confidence that each located object or element was not extracted earlier during the process. This process is algorithmically similar to that described in conjunction with FIG. 8b with only difference that here the search is implemented in nodes of a two dimensional rectangular net with equal or different discretization steps along both coordinates.

Alternatively, other methods of information extraction can be used. A detailed comparison of different methods and selection of the optimal method depends on the particular system configuration and is thus beyond the scope of the present description.

Information extractor 42 (FIG. 12) preferably extracts all of the available data, preferably through temporary graphic, textual and contextual copies of the available area, and uses this data to construct strong bidirectional unique conformity of contents with geometrical location.

Information extractor 42 preferably performs the following tasks:
1. Collection of all context and interface information (see also the description of the “Context Branch” in conjunction with FIG. 7) with connection to geometric location.
2. Collection of all textual information also with full location data such that the minimum location/geometric data includes at least the location of each word location within each text portion.
3. Construction of a one to one graphic copy or screenshot of the screen—similar to a ‘Print Screen’ operation—and stores the resulting bitmap in a memory. Preferably this is a memory other than the Clipboard which can be used for other purposes.
4. Making separate copies of all graphic objects, storing them also in the memory because some may be changeable. For example, Google® maps always open to show the same default location preselected by user; such a map display can be changed by the user, for example by shifting it in a desired direction or zooming it.
5. Optionally analysis of all graphic objects for the presence of OCR extractable information, extraction thereof and binding the resulting texts with the original objects contextually, and geometrically expanding the number of object descriptors.
6. Analysis of all graphic objects for accessible properties, including: the presence of text equivalents (alternative text or descriptive text), determining an “image map”; wherein, for example, an image may be separated into a number of regions where each is a link to another Web page, and so on). This also expands the number of object descriptors.

Information analyzer 43 is operative to process separately the graphic, textual and contextual data received from information extractor 42. Such processing is implemented in a manner similar to that of correspondingly named components in the other channels in FIG. 7.

Accordingly, while the above-described information extraction and processing in transformation and navigation channels are generally similar, there is a significant difference in the manner of their operation. Branches 1, 2 & 3 (FIG. 11) are concerned with local data in the vicinity/neighborhood of the THS, such as a single graphic object, a single portion of text, or a single contextual/interface object. In contrast, navigation channel 4 and the constituent functional elements thereof, namely information extractor 42 and information analyzer 43 (FIG. 12) process all the data in the available area.

Components of information analyzer 43 responsible for the analysis of graphic data filter out all unimportant graphic elements and objects, including but not limited to separators, as well as other application environmental objects extracted with the context extracting branch. Such filtering significantly decreases the number of graphic objects to be analyzed in detail. Information analyzer 43 is also operative to perform a detailed analysis of “real” graphic objects, such as pictures, graphs, diagrams, and the like.

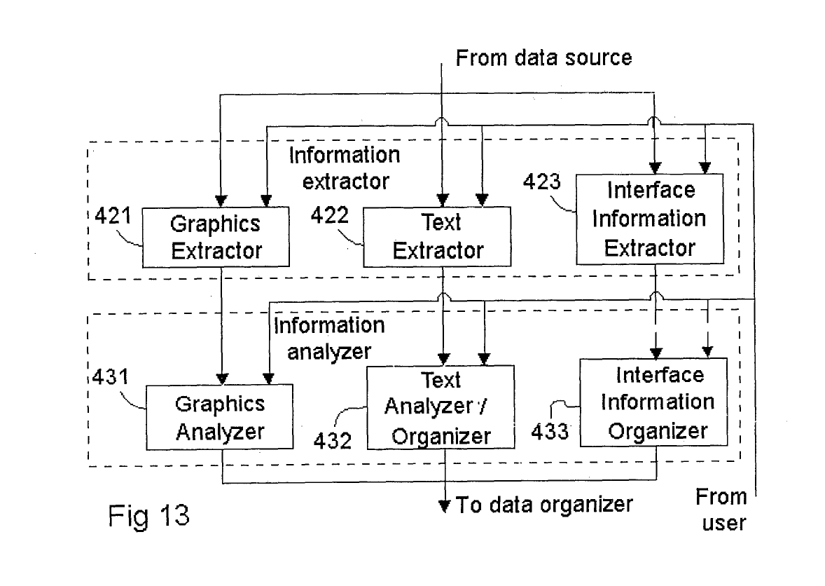

Referring now to FIG. 13, information extractor 42 (FIG. 12) is shown in to include a graphics extractor 421, such as mentioned above in conjunction with the prior art, a text extractor 422 and a context extractor 423, each of which operates according to the above description and also with regard to the previous description of correspondingly named components in the other “branches”.

Information analyzer 43 (FIG. 12) further includes, as seen in FIG. 13, a graphic analyzer 431, a text analyzer/organizer 432 and a context organizer 433, which preferably operate according to the description provided below and also with regard to the previous description of correspondingly named components in the other “branches”. Text organizer 432 and context organizer 433 preferably operate as previously described; their output is provided to data organizer 44 (FIG. 12).

Referring once again to FIG. 12, data organizer 44 is operative to receive from information analyzer 43 a set of discovered objects of different types (graphic, textual and contextual) with their descriptors such as name, type, function, location, status, and so on. Before being stored, as seen at database 46, the set passes through several stages of processing, including filtering, integration and optionally, enhancement.

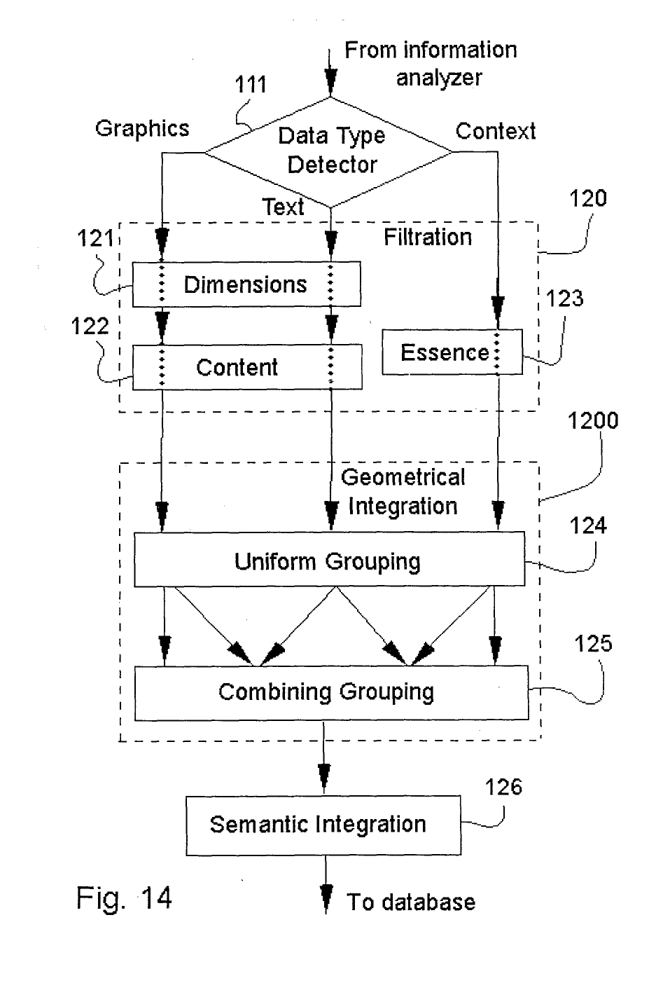

Referring now to FIG. 14, there is shown a combined block diagram and top level flow chart representation of data organizer 44 (FIG. 12).

Data processed in information extractor 42 (FIG. 12) and information analyzer 43 (FIG. 12) is divided according to its type by data type detector 111. Depending on whether it is graphic, text or context data, it is passed through a predetermined filtering channel, as described below.

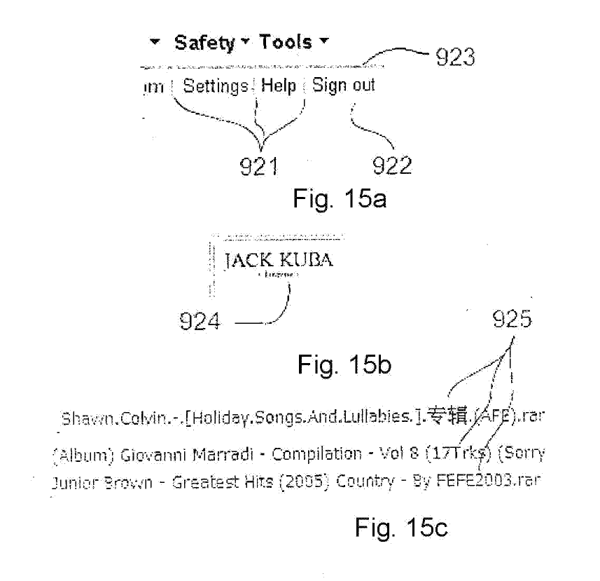

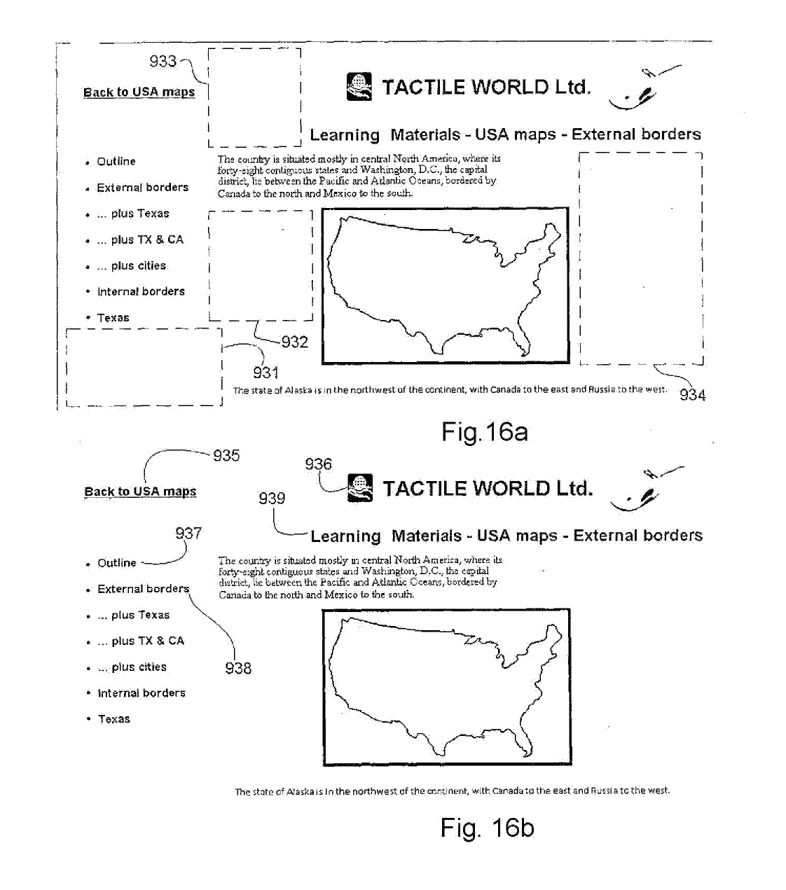

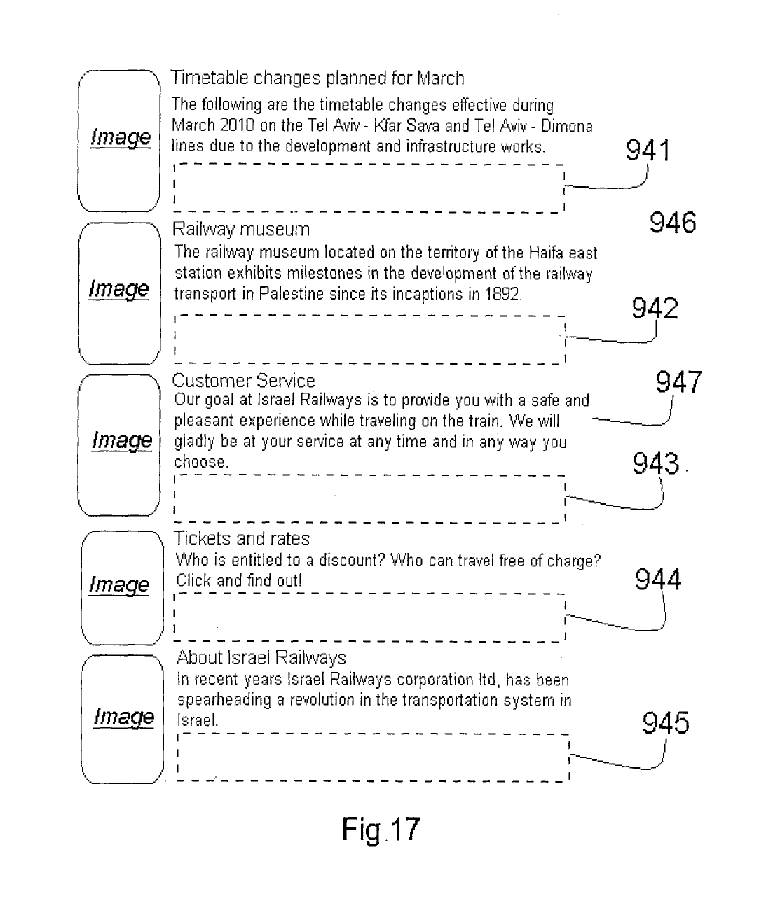

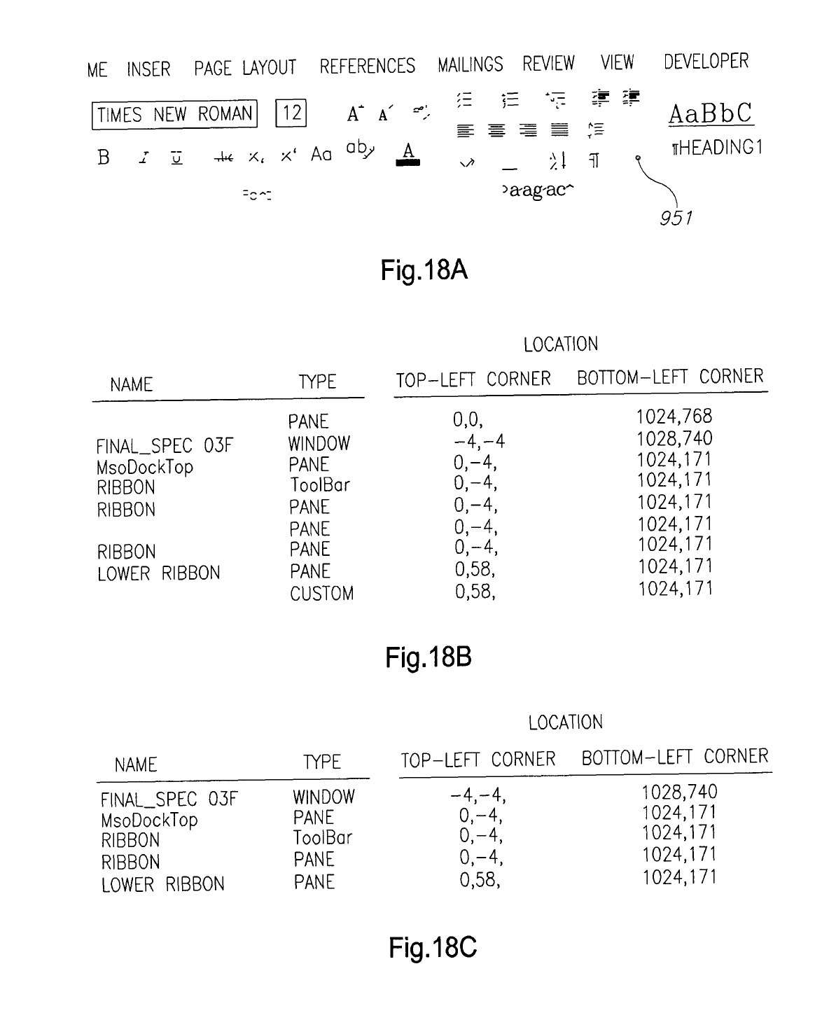

In the filtering stage 120 of data organizer 44 (FIG. 12), objects that are either not relevant or not significant are filtered out. Most of these objects are graphics-like separators, or others as may be defined in the system. Contextual elements to be filtered mostly appear in many websites as result of multiple reorganizations, changes, and so on.
1. The filtering of “small” objects is performed, as seen in block 121. Small graphic objects are normally of little importance, merely having separating or decorative functions, such as exemplified by in FIG. 15a by the short vertical lines 921 for separating different hyperlinks; a thin grey horizontal line 922 which graphically separates a narrow strip containing a set of hyperlinks from another area of the window; and a black line 923 which is a border between the service area of an application and its information area. A further example is seen in FIG. 15b, in which a text sub-line 924 is a part of graphical advertisement which cannot be extracted contextually with such small resolution and should be filtered out. Finally, seen in FIG. 15c is a set of file titles having a large plurality of symbols 925 which, possibly, are necessary for successful file search within a global database but are not normally required by most users, and which can be removed.
   Referring once again to FIG. 15a, it will be appreciated that the short vertical lines 921 separating the hyperlinks shown, may appear in some websites to be not graphical, but the textual symbol “|”. Such symbols also should not be included into database 46 but should be filtered on this processing stage.
2. The erasing of apparently “empty” elements is performed, as seen in block 122. These large elements are simply large areas which either contain no features, and/or are formed of an area of uniform color. Such empty elements are problematic with regard to both orientation and navigation, due to the fact that display of such an area when simply magnified, provides the user with no information where to go in relation to his/her current position. Black and white examples of such areas enclosed by thin dashed rectangles are shown in FIG. 16a, in which the regions marked as 931, 932, 933 and 934 contain no orientation or navigation information when they are magnified. Accordingly, such areas excluded from redisplay in the present invention. Specifically, they are excluded from database 46 (FIG. 12), so that it stores only information which is useful with respect to orientation and navigation. Algorithms for the identification of such “empty” regions are well known in image processing. Typically they are based on the discovery of empty seed areas with following growing algorithms, as well known in the art, and therefore, are not described herein.
   By way of further example, FIG. 16b shows data elements whose descriptors are stored after erasing of the “empty” areas. Thus, when the user moves THS from element 935 to right, the content of the output area changes instantly to show element 936, thereby skipping over the empty area between them. Similarly, moving the output area from logo block 936 to the left, link ‘Back to . . . ’ 935 will be displayed; and moving from link 935 downwards, link ‘Outline’ 937 will be displayed in the output area; and the same will happen (i.e. skipping over the blank regions) when moving from link 937 to the hyperlink ‘External borders’ 938, and from the logo block 936 to the text ‘Learning materials . . . ’ 939.
   A similar situation is shown in FIG. 17 for the empty areas marked 941-945, each surrounded with a dashed rectangle, between text blocks. Not including these areas in the database provides a logical proximity of the text blocks, such that upon movement of the output area from a text block 946 towards, for example, a text block 947, the empty area 942 will be skipped and the subsequent text block will be displayed.
   Algorithmic implementation of the discovering of “empty” areas among text blocks differs from discovering of graphically empty areas. Many software packages used for text extraction (like the ‘Word/Text Capture’ software tools mentioned above) besides their main task, namely, the extraction of texts, also provide screen coordinates for each text block. Therefore, regions found to be devoid of text are subsequently checked for the absence of graphics, as described above, and if no significant graphic elements are found, these regions are excluded from database 46.
3. The erasing of “meaningless” objects is performed, as seen in block 123. For various reasons, mostly due to flaws in software packages for website development, many contextual objects that may be discovered as described above, may have no useful purpose for orientation/navigation purposes. Such elements are containers and their components: panes, customs, some types of tabs, etc. They also can appear in regular software applications. FIG. 18a demonstrates a fragment of the MS Word® application. A software tool based on MS UTA library applied to location 951 (FIG. 18a) outputs hierarchical information for the element “Custom”; this chain is shown in FIG. 18b. The element “Custom,” appears at the bottom of the column entitled “Type”, and has no name (see column entitled “Name”). Three rows above there is the element “Pane” which also has no name, similar to the top element, also “Pane” in the “type” column. This information cannot help in orientation or navigation and is thus excluded from database 46. The algorithmic indication for such exclusion or filtration is the absence of a name or caption for these elements and the partial or complete covering of elements. Next step of such erasing of meaningless objects is discovering of extracted repeating objects such as the fifth line in the table from FIG. 18b. Thus, finally the table determining hierarchical chain for location 951 stored in the data base 46 will look as it is shown in FIG. 18c.

The filtering as described above, significantly decreases the number of graphic objects to be analyzed in detail and stored in database 46.

During the integration stage 1200, there are grouped different objects which may either be of the same or different types, in order to facilitate navigation for the user. Such grouping may be based on geometrical and/or semantic considerations, as per the following examples.

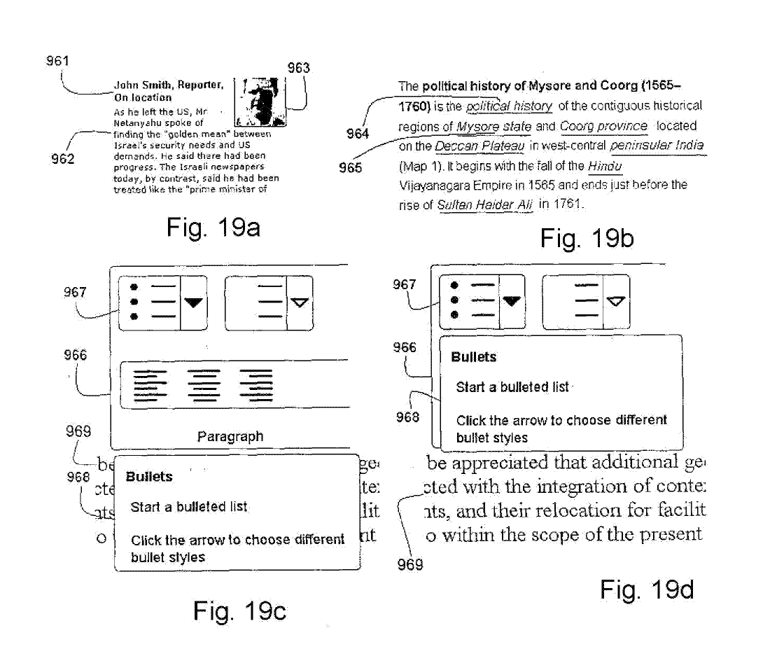

Among examples of geometrical grouping, are the following:
1. A text heading and a text fragment located geometrically below the heading are grouped together as a single article. Referring now to FIG. 19a, there is shown an example of the grouping of the header 961 of an article with the text 962 thereof. Logically, such grouping is useful for facilitating of navigation to this material: wherein a first “jump” to the article should logically go to its header, rather than skipping the header and going straight to the first word of the text. From this example it is clear that the image 963, although being of a different type, could also be included in the group, as it is related to the text article. Algorithmically such a grouping can be based on pure geometrical considerations, whereby all three elements are located within a single rectangular area.
2. Hyperlinks embedded in a text paragraph are grouped as single text items, as seen in the example of FIG. 19b. Depending on the exact implementation of the information extraction algorithm, hyperlinks 964, 965 and others (all shown in italicized highlighted font) can be classified as contextual elements which are separate from the surrounding text. Alternatively, however, they should also be considered as integral parts of the text. Therefore, they will either be stored in data base twice, or they will be assigned with a special pointer or other indicator characterizing them as dual purpose elements.
3. A curve located to the right of a vertical line and above a horizontal line intersecting with the vertical line is considered as a graph in Cartesian coordinates, such that all three lines are grouped together. Further analysis can expand this grouping so as to include a curve continuing below that horizontal line, rising back and so on. Possible algorithms are based on well known procedures of image processing allowing detection, enhancement and expansion of curves and, in particular, straight lines.
4. A short text located inside or on a button is deemed to be a caption of that button and is thus grouped therewith. The same can be discovered on the stage of hierarchy chain construction (see above).
5. A pop-up or tip window 968 associated with an icon 967 located on the Paragraph group 966 of MS®Word® Home menu panel appears when the mouse cursor moves over the icon, for example, as shown in FIG. 19c. It can be grouped together with the icon 967. This permits displaying the tip 968 in the same selection area as the icon 967. Therefore, the coordinates of the location of the tip are associated with those of the icon, for example as shown in FIG. 19d, preferably so as not to hide other important information to the user.

It will be appreciated that additional geometrical groupings connected with the integration of contextually associated elements, and their relocation for facilitating of navigation tasks, are also within the scope of the present invention.

Referring once again to FIG. 14, the integration or grouping of elements as described above, is provided by two steps, as follows:

The first step, seen in block 124, entails the grouping of “uniform” elements, namely groups of elements of the same types, such that graphic elements will be grouped together with other graphic elements, textual with textual, and contextual with contextual.

The second step, seen in block 125, entails the geometrical grouping of elements from different informational groups such as shown in FIGS. 19a-d.

After integration as described above, a further integration or grouping is performed, namely, semantic integration, as seen in block 126 (FIG. 14), in which the following types of grouping may be performed:

text fragments are combined into continuous portions or articles of text;

objects which are of uniform context such as headers with articles and embedded images, text-links and image-links pointing to the same addresses and so on.

Among other examples of semantic grouping are the following:
1. Two parallel columns of text can belong to the same article and therefore they are combined. The algorithms described in conjunction with FIGS. 4, 5 and 6 can be applied in such a case.
2. An image wrapped to a text will not divide the text into different portions.
3. An image having descriptive text with its connected article located somewhere separately within the available area.

The above are only examples, of course, a very large number of different possibilities, indicative of the fact that semantic grouping is a complex problem which is a part of extensively developed area known as Semantic Analysis. Detailed descriptions of some of the more common types of semantic analysis can be found, for example, at http://lsa.colorado.edu/papers/dp1.LSAintro.pdf and http://www.discourses.org/OldArticles/Semantic%20discourse%20analysis.pdf. There also exists software and SDKs (Software Development Kits) for this purpose. Some of them can be found in http://infomap-nlp.sourceforge.net/or http://software.informer.com/getfree-latent-semantic-analysis/ and other internet locations. These tools for semantic analysis and grouping are well known to persons skilled in the art, and are outside the scope of the present invention.

Referring once again to FIG. 12, data organizer 44 is further operative to build a hierarchical structure of all objects with the data source 10 itself as a root. A non-limiting example of such a hierarchical structure for a schematic appearance of a desktop of computer screen display is shown in FIGS. 20a and 20b; a use of these structures is demonstrated in FIGS. 20c and 20d.

The display schematically illustrated in FIG. 20a contains the following GUI elements:
1. a desktop upon which are the icons labeled Ic1-Ic6, two icons Ic3 and Ic6 are hidden under active window W.
2. a program bar containing
   2.1. “Start” button;
   2.2. a quick launch bar having three links L1, L2 and L3;
   2.3. task bar having displayed thereon four tasks respectively labeled “Task 1”, “Task 2”, “Task 3” and “Task 4”;
2.4. a system tray having two icons I1 and I2, and a clock, labeled “Time”; and
3. Window W with two objects Wo1 and Wo2.

FIG. 20b shows how these GUI elements are organized into a hierarchical structure with the screen as its root hierarchical level. Icons Ic3 and Ic6 do not appear in the hierarchy because they are hidden.

The existence of this hierarchy facilitates easy navigation among all essential data elements in the data source. The user implements navigation activities with a help of navigation tools 81. These tools may include both specially created devices (joystick, tactile or haptic mouse, touch panel, etc) and regular input devices (joystick, mouse, etc) switched to special navigation mode.

In order to understand basic navigation from one data object to a hierarchically adjacent object, reference made to FIG. 20c.
a. An object selector, which may be a joystick or an especially adapted computer mouse, for example, can be moved in a two dimensional space having North, East, South and West directions. In FIG. 20c the object selector's pointer points to an object from the currently constructed hierarchy stored in database 46, shown as “Object A”;
b. Object A itself and/or its descriptors are shown in the system's output area;
c. Moving the object selector to the North direction brings the pointer to the hierarchical parent of object A;
d. Moving the object selector to the West direction brings the pointer to the hierarchical sibling to the left of object A;
e. Moving the object selector to the East direction brings the pointer to the hierarchical sibling to the of object A;
f. Moving the object selector to the North direction brings the pointer to the hierarchical first child of object A;
g. Simultaneously with moving the pointer to another object B (not shown), the object

B itself and/or its descriptors are shown in the output area. All such jumps can be accompanied by audio prompts.

This method can be successfully applied for solution of any navigation problems in the embodiment of the present invention. FIG. 20d illustrates its implementation for two navigational tasks.

Suppose the user sees the icon Ic2 and/or its descriptors in the output area of the system. He knows that all other icons visible on the screen are siblings of the icon Ic2 and can request a list of visible icons constructed by survey builder 45 (FIG. 12). This means that a current orientation problem has successfully solved by the user. The user decides to watch another icon (for example Ic5 in FIG. 20a). He makes two consecutive shifts right (East) of the object selector—arrows 1001 and 1002 in FIG. 20c. Such shifts switch contents of the output area from Ic2 first to Ic4 and then to Ic5 solving the current navigation task. Another example of a navigational task consists in switching from watching of window object Wo2 to watching the task icon Task 2 on the task bar of the program bar. If the user knows the hierarchy, in order to navigate from Wo2 to Task 2 his actions will be:
Move the object selector North (Up) to Wo2's parent Window W (arrow 1003 in FIG. 20d)
Move East to the right sibling “Program bar” along arrow 1004
Move South to the Program bar's first child “Start button” along 1005
Move East to right sibling “Quick launch” along 1006
Again East to right sibling “Task bar” along 1007
South to first child—“Task 1” along 1008
East to the search target—“Task 2” along 1009.
If the user by any reason does not know the current hierarchy but knows the hierarchy principle, he/she can use the method of try and error on the current hierarchy. It will be a finite process in the contrast to a ‘blind’ search made without such navigation capabilities.

The survey builder 45 also receives the result of the data analysis from information analyzer 43 and creates survey descriptions for the available area as a whole and for all potential areas of interest. The survey descriptions include a list of all data items in the available area as well as the geometrical locations of these data items.

Such surveys can also be organized hierarchically in a manner similar to the structure shown in FIGS. 20a and 20b. For example, for the illustrated computer display such structure may include the following top level nodes:
a) a survey of the screen contents,
b) a review of the desktop contents,
c) a list and main characteristics of open windows and applications,
d) a summary description of the contents of each window including lists of links, controls, images, headers, and the like with their main features and components.

All of the above data is then preferably stored in database 46 together with all extracted and processed data.

In addition to their informational value, the above listings of descriptors and surveys serve for navigation purposes providing:
Search capabilities for the selection of desired areas of interest and methods of reaching them, e.g. by selection from a list, by special THS motion in the navigation mode, and so on;
Search options for graphic objects, text fragments, hyperlinks, headers, menu items, etc with or without automatic shift of the output are straight to the target object.

As mentioned above with regard to FIG. 11, when a significant change of information content occurs within the data source 10, the system renews the contents of database 46 so as to update the information required for orientation and navigation. Typical examples of large variations are: opening a new window, the appearance of a new dialog box, a change of the active web page, switching of the visible page of a document being viewed, a sudden change in the zoom factor, turning of a newspaper page, and so on. Such variations cannot be handled by the mere adjustment of database 46 contents, and its entire contents must be refreshed. In cases of relatively small variations in the contents of the data source, however, the existing information in the database may be adjusted instead of being completely refreshed.

In accordance with further embodiments of the invention, there is provided an automatic adjustment of available navigation tools in response to “small” variations in the contents of data source 10 and the renewal of database contents. Examples of small variations in contents include: pressing of “Line up”==“Back by small amount” button of a scroll bar, small shift or rotation for small angle of image, smooth change of image contrast, shift of text line for one symbol, and many others. Principally, compensation for such variations can be made by appropriate adjustments of data stored in the database 46.

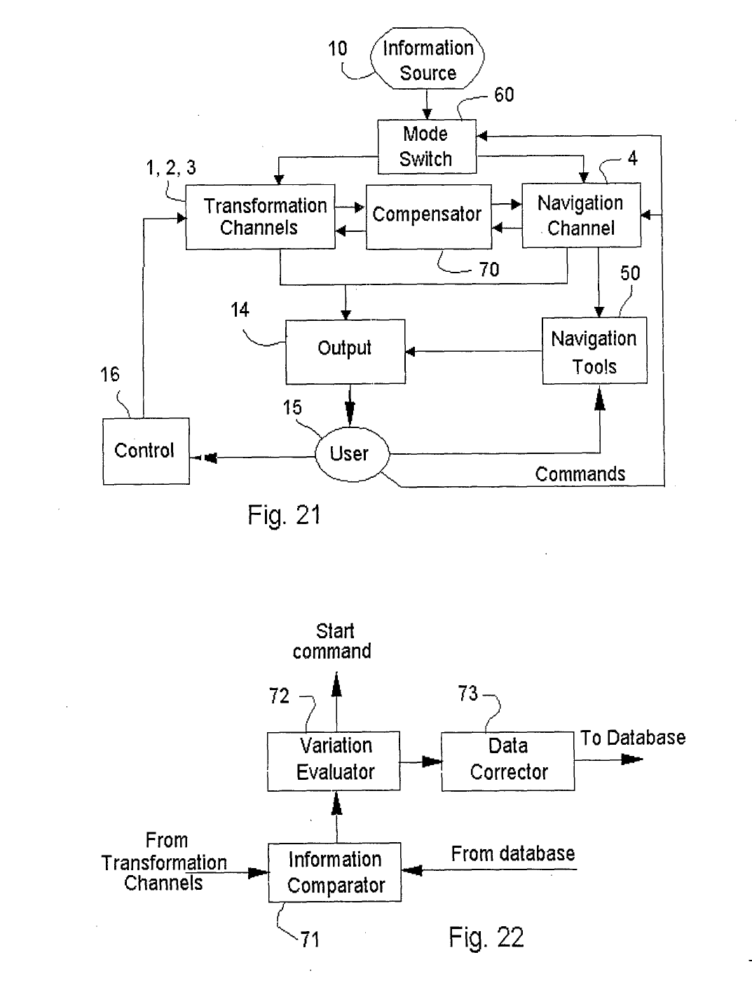

An implementation of this functionality is shown in FIG. 21 which is the system shown and described above in conjunction with FIG. 11, but also including a compensator, referenced 70. Compensator 70 is operative to compare the “current” data, namely, data received in real time from transformation channels 1, 2, 3 with “previous” data stored in database 46 (FIG. 12).

The compensator 70 operates in real time. It receives extracted data from transformation channels 1, 2, 3 from the vicinity of the current THS location, and receives data from the database 46 corresponding to that THS location. If the data regarding these locations is the same, then nothing is done. If one or more locations require correction, corrective data from transformation channels 1, 2, 3 replaces the previous data for these locations in the database 46. If the discrepancy in the data is not correctable, such as if it is greater than a predetermined discrepancy/threshold, compensator 70 issues a command to initiate a new process of extraction, collection and renewal of the data database 46.

As seen in FIG. 22, compensator 70 (FIG. 21) includes three basic elements, namely, an information comparator 71, a variation evaluator 72, and a data corrector 73.

Information comparator 71 is adapted to receive from the transformation channels 1, 2, 3 real time graphic, textual and contextual data which is located in the vicinity of the THS. Comparator 71 then requests matching data from database 46, and compares corresponding graphics versus graphics, text versus text, and context versus context portions, and provides the results of these comparisons to the variation evaluator 72.

Subsequently, variation evaluator 72 checks the results of the comparison with predetermined threshold values Tₘᵢₙ and Tₘₐₓ for each of the evaluated parameters. If a certain parameter has a value Cₚ which is less than its Tₘᵢₙ, no corrective action will be taken. If Cₚ is greater than Tₘᵢₙ but less than Tₘₐₓ, the change is deemed to be small enough such that it can be corrected within the database 46. If Cₚ is greater than Tₘₐₓ, the trigger 41 initiates process of renewal of database 46.

In order to understand what may constitute a “small” change in a website leading to correction of database made without requiring the renewal of its entire contents, the following example is provided. The entering of a word in an edit box, for example, “Sport”, leads to the appearance of this word in the “VALUE” field among the descriptors of this edit box stored in the database 46.

A further example of what may be considered to be a “small” change is given for a text in the working area of an MS Word® document. As previously described the database 46 contains location and formatting data for each word of that text. The selection of several words causes these words to be highlighted in the document as displayed, and changes corresponding fields in the database. The remaining contents of the database are unchanged. A variation in the formatting of those words from Normal to Bold effects a corresponding change in the contents of the database fields, at the same time erasing the information concerning the selection of the three words.

Although embodiments of the invention have been described by way of illustration, it will be understood that the invention may be carried out with many variations, modifications, and adaptations, without departing from its spirit or exceeding the scope of the claims.

1. An intelligent data display system which includes:
a complex data source for the storage and display on a visual display device of data of different types, including at least image data and text data;
at least two transformation channels for the extraction from said data source of data elements of a selected type and for the transformation of the extracted data elements into a selected display format including:
an image channel for the extraction and transformation of image data, and
for the provision of transformed image data as a formatted image data output; and
a text channel for the extraction and transformation of text data, and for the provision of transformed text data as a formatted text data output; and
an output for receiving the formatted data output and for redisplaying it on said display device.

2. A system according to claim 1, wherein the image and text data is displayed on said display device in an available area, and wherein system also includes a user operated selector for selecting displayed data from a user indicated area of concentration on said display device, smaller than the available area, for transformation and redisplay.

3. A system according to claim 2, wherein said text channel is operative to extract text data from the area of concentration, and also includes a text organizer for identifying and removing non-textual elements such that only text elements remain within the extracted text data, and to connect together text elements separated by the removed non-textual elements.

4. A system according to claim 3, wherein said text organizer is also operative to identify text elements lying outside the area of concentration, but forming part of the body of text lying within the area of concentration and contiguous therewith, and to connect together the contiguous text elements so as to form at least one contiguous portion of text for redisplay.

5. A system according to claim 2, wherein said user operated selector includes a cursor indicating a specific location on the available area, and said at least two transformation channels also include an orientation channel for determining the specific location of said cursor and for identifying a basic data element at that location, and further, for providing as output, orientation information for assisting the user in planning further steps with respect to the currently displayed data.

6. A system according to claim 5, wherein the specific location of said cursor is selected from the following group:
the current geometrical location of said cursor; and
the current information location of said cursor.

7. A system according to claim 6, wherein said orientation channel is also operative to determine the position of the specific location of said cursor relative to one of the following:
the currently displayed data; and
the available area.

8. A system according to claim 7, wherein said orientation channel includes:
a locator for determining the presence of an element related to the basic data element, to be extracted when said cursor is positioned wherever; and
an extractor for extraction of the related element and its descriptors in response to a user request, as orientation data.

9. A system according to claim 8, wherein the related element is of the type selected from the following list:
a data element that is geometrically related to the basic element; and
an element that is contextually related to the basic element in accordance with the position thereof in the hierarchical listing in said database.

10. A system according to claim 9, wherein said orientation channel is also operative to provide the orientation data for display to a user on said display device.

11. A system according to claim 10, wherein said orientation channel also includes a search director, for conducting a search for elements related to the basic element in accordance with user selected criteria.

12. A system according to claim 11, also including a navigation channel for assisting a visually impaired user in navigating to any selected data element within the available area, wherein said navigation channel includes tools for constructing a database including a hierarchical listing of data in said data source.

13. A system according to claim 12, wherein said tools for constructing a database include a compensator for updating the contents of said database in real time in response to small variations in the contents of the data source.

14. A method for redisplay of a display of data of different types on a visual display device, including at least image data and text data, including the following steps:
extracting image data;
transforming the extracted image data;
providing the transformed image data as a formatted data output;
extracting text data;
transforming the extracted text data;
providing the transformed text data as a formatted data output;
redisplaying said formatted image data output and text data output on the display device.

15. A method according to claim 14, wherein the image and text data is displayed on the display device in an available area, and wherein said method also includes the following steps, prior to said steps of extracting:
indicating an area of concentration on the display device, smaller than the available area; and
selecting data from the area of concentration a user indicated, for transformation and redisplay.

16. A method according to claim 15, wherein said step of transforming the extracted text data from selected area includes the steps of:
extracting text data from said area of concentration;
identifying and removing non-textual elements such that only text elements remain within the extracted text data; and
connecting together text elements separated by the removed non-textual elements.

17. A method according to claim 16, wherein said step of extracting text data from said area of concentration also includes:
identifying text elements lying outside the area of concentration, but forming part of the body of text lying within the area of concentration and contiguous therewith, and
connecting together the contiguous text elements so as to form at least one contiguous portion of text for redisplay.

18. A method according to claim 15, wherein said step of indicating includes indicating by use of a cursor, and said method also includes the following steps:
determining the location of said cursor;
identifying a basic data element at that location; and
providing orientation information as an output, for assisting the user in planning further steps with respect to the currently displayed data.

19. A method according to claim 18, wherein said step of determining the location of the cursor includes the step selected from the following group:
determining the current geometrical location of the cursor; and
determining the current information location of the cursor.

20. A method according to claim 19, wherein in said step of determining the location of the cursor also includes determining the position of the location of the relative to one of the following:
the currently displayed data; and
the available area.

21. A method according to claim 20, wherein said step of determining the location of the cursor also includes the following steps:
determining the presence of an element related to the basic data element, to be extracted when said cursor is positioned wherever; and
extracting the related element and its descriptors in response to a user request, as orientation data.

22. A method according to claim 21, wherein said related element is of the type selected from the following list:
a data element that is geometrically related to the basic element; and
an element that is contextually related to said the element in accordance with the position thereof in the hierarchical listing in the database.

23. A method according to claim 22, wherein in said step of determining, said related element is of the type selected from the following list:
data elements located within the area of concentration; and
data elements located from a location within the available area, but outside of the area of concentration.

24. A method according to claim 23, and also including the step of constructing a database including a hierarchical listing of data in said data source, so as to assist a visually impaired user in navigating to any selected data element within the available area.

25. A system according to claim 24, and also including the step of updating the contents of the database in real time so as to compensate for small variations in the contents of the data source.
